(19) United States
(12) Patent Application Publication
(10) Pub. No.: US 2002/0039181 A1
(43) Pub. Date: Apr. 4, 2002

(54) Modeling a coloring process

(75) Inventors: Tarja Shakespeare, Siuro (FI); John Shakespeare, Siuro (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy, Tampere (FI)

(21) Appl. No.: 09/851,812

(22) Filed: May 9, 2001

Related U.S. Application Data
(60) Provisional application No. 60/198,252, filed on May 9, 2000.

(51) Int. Cl. G06K 9/00

(52) U.S. Cl. 356/73.1

(57) ABSTRACT

The invention relates to a method and an apparatus for controlling a coloring process. In the coloring process, at least one fluorescent or non-fluorescent ingredient is added and the color of the substrate is determined by using a coloring model which describes the effect of said ingredient on the radiance transfer factor for the substrate to be colored. The color is controlled by the amount of said ingredient that is added in the coloring process

### FIELD OF THE INVENTION

The invention relates to a coloring process in which fluorescent and/or non-fluorescent ingredients are used.

### BACKGROUND OF THE INVENTION

Measurement and control of color are particularly important in process industry. For example, the paper industry's demand for high white paper products is increasing. This requires usage of well-bleached fibers, non-fluorescent colorants and high dosage of fluorescent brightening agents (FBAs). Paper can be colored using three methods: stock coloring, surface coloring or a combination of the two. In stock coloring the paper is dyed throughout, with dyes either added in dyebath or metered in furnish with good mixing.

Fluorescent brightening agents and other fluorescent colorants absorb radiant energy in a particular energy band and then partially re-emit the absorbed energy as radiance at lower energy bands. Customers are also less tolerant of variation in color, both within and between batches. The dosing level of FBAs for high white paper grades is quite often near the saturation point. Specialty paper makers may also use fluorescent colorants for shaded grades, in combination with non-fluorescent colorants and sometimes FBAs. As a result, paper makers are faced with challenges in specification, measurement and control of color in fluorescent grades. Current laboratory and on-line spectrophotometric measurement instruments, while conforming to various standards, employ a number of different compromises in measuring color. Although relatively innocuous for measurement of non-fluorescent grades, some of these compromises have serious consequences for measurement of fluorescent grades.

In paper industry in particular, color control is often based on the Kubelka-Munk theory, although there are several multi-flux models which allow calculation of the infinite stack reflectance from measurements of a single sheet sample reflectance and transmittance by applying a known method, and some knowledge of the relative absorbing and scattering power of the sample. The Kubelka-Munk two-flux theory is applicable to diffuse light fluxes in both directions. Another is the four-flux theory, which incorporates directional light fluxes in addition to the diffuse light fluxes. The equations and methods of multi-flux models, including the four-flux and Kubelka-Munk two-flux models, may be found among others in Völz, H. G., “Industrial Color Testing”, VCH, Weinheim Germany, 1995, which is incorporated herein by reference- According to the Kubelka-Munk theory, a reflectance factor R is estimated R=1+K/S−[(1+K/S)²−1]^{½}, where K is an absorption coefficient and S a scattering coefficient. The absorption coefficient K and the scattering coefficient S can both be measured from the object to be measured by applying known methods. Colorant formulation (colorant modelling/color control) based on Kubelka-Munk theory is presented in R. McDonald (editor), Colour Physics for Industry, 2. Edition, p. 209-232, Society of Dyer and Colorists, 1997, which is incorporated herein by reference.

In dyebath the coloring process may follow a Langmuir-type adsorption isotherm. Various other adsorption isotherms such as BET and Freundlich have also been used in dyeing studies. The BET isotherm is the most flexible, but has not been used much in dyeing studies, mainly due to the number of required parameters. The Freundlich isotherm does not have a limiting saturation value of dye-on-fiber. This cannot be physically justified in stock dyeing. The Langmuir isotherm can be applied to most dyeing processes involving hydrophilic fibers that can be colored with fluorescent and/or non-fluorescent colorants.

According to the Langmuir isotherm it is assumed that an adsorbent surface is uniform and homogenous, a single layer of adsorbed material is layered on the adsorbent, and temperature is constant during the process. Additionally all adsorption sites are equivalent, and adsorbed molecules are considered to be non-interacting and immobile. That leads typically to a complex function between the concentration of the adsorbate in the dye-bath and the amount of material adsorbed. The adsorption process is usually modeled as a second order reaction between molecules from the fluid and vacant adsorption sites, and desorption as a first order reaction. The resulting concentrations of adsorbate in solution are plotted against the concentrations of adsorbate in the adsorbent phase.

There are, however, problems to apply Kubelka-Munk theory and Langmuir isotherm to a coloring process. The multi-flux theories do not incorporate fluorescence or other spectral transformations; they only model absorption and scattering phenomena. For this reason, attempts have been made to extend the Kubelka-Munk theory to also cover fluorescent ingredients, one of these attempts being disclosed in Bonham, J., S., “Color research and applications” in “Fluorescence and Kubelka-Munk Theory”, Vol. 11, number 3, 1986, which is enclosed herein as a reference. The solution is verified for daylight fluorescent colorants absorbing and emitting in visible band. However, the solution in question depends on the used illumination, and therefore the results are not transferable between measuring instruments. The quantum efficiency is expected to be independent of the excitation wavelengths. In addition, the solution has been simplified by assuming the scattering coefficient S to he independent of wavelength and independent of the colorant concentration in substrate.

The Langmuir isotherm based on the above mentioned assumptions does not model accurately enough the coloring process. For example direct anionic dyes form aggregates that cannot be dealt with the assumption of mono layer adsorption only, and it does not give tools to model absorption band broadening caused by aggregated dye molecules and the peak emission shift towards longer wavelengths causes by aggregated FBA molecules.

### SUMMARY OF THE INVENTION

It is therefore an object of the present invention to provide an improved method and an apparatus implementing the method. This is achieved with a method for controlling a coloring process, the method comprising adding at least one fluorescent ingredient in the coloring process; determining the addition amount of said at least one fluorescent ingredient by using a model which describes the effect of at least said at least one fluorescent ingredient on a radiance transfer factor for a substrate to be colored.

The invention also relates to a method for controlling a coloring process, the method comprising adding at least one soluble ingredient into a coloring solution; exposing a solid substrate to said coloring solution, and thereafter separating said solid substrate from said solution determining the addition amount of said at least one soluble ingredient to impart a desired color to the substrate by using a model which describes in combination; the adsorption or deposition or absorption of said at least one dissolved soluble ingredient onto the surface or into the material of said solid substrate in terms of a concentration of said soluble ingredient in the coloring process, and the effect of adsorbed or deposited or absorbed said at least one soluble ingredient on an optical spectral property of said solid substrate,

wherein said model contains at least two terms for the at least one soluble ingredient, the terms being added or subtracted, and each of said at least two terms comprising a product of a spectral function and a function of concentration, and not all spectral functions of all terms are identical, the model generally taking the form

$$\frac{\partial p ( λ )}{\partial c} = {g}_{1} ( λ ) {f}_{1} ( c ) + {g}_{2} ( λ ) {f}_{2} ( c )$$

where p(λ) is the spectral property of the substrate, g₁(λ) and g₂(λ) are known spectral functions which are not identical, and f₁(c) and f₂(c) are known functions of concentration.

The invention also relates to a method for controlling a coloring process, the method comprising adding at least one fluorescent ingredient in the coloring process; determining the addition amount of said at least one fluorescent ingredient to impart a desired color to the substrate by using a model which describes the effect of at least said at least one fluorescent ingredient on a radiance transfer factor for a substrate to be colored; said model contains at least one term for the at least one fluorescent ingredient, the term comprising a product of a spectral transfer function and a function of concentration, the model generally taking the form

$$\frac{\partial p ( ζ , λ )}{\partial c} = g ( ζ , λ ) f ( c )$$

where p(Ξ, λ) is the radiance transfer factor of the substrate g(Ξ, λ) is a known spectral transfer function, and f(c) is a known function of concentration.

The invention also relates to a method for controlling a coloring process, the method comprising adding at least one fluorescent ingredient in the coloring process; determining the addition amount of said at least one fluorescent; ingredient to impart a desired color to the substrate by using a model which describes the effect of at least said at least one fluorescent ingredient on a radiance transfer factor for a substrate to be colored; said model contains at least two terms for the at least one fluorescent ingredient, each term comprising a product of a spectral transfer function and a function of concentration, one spectral transfer function differs from at least one other spectral transfer function, the model generally taking the form

$$\frac{\partial p ( ζ , λ )}{\partial c} = {g}_{1} ( ζ , λ ) {f}_{1} ( c ) + {g}_{2} ( ζ , λ ) {f}_{2} ( c )$$

where p(Ξ, λ) is the radiance transfer factor of the substrate, g₁(Ξ, λ) and g₂(Ξ, λ) are known spectral transfer functions which are not identical, and f₁(c) and f₂(c) are known functions of concentration.

The invention also relates to a method for controlling a coloring process, the method comprising adding at least one fluorescent ingredient in the coloring process; determining the addition amount of said at least one fluorescent ingredient to impart a desired color to the substrate by using a model which describes the effect of at least said at least one fluorescent ingredient on a radiance transfer factor for a substrate to be colored; the radiance transfer factor being determined from: the optical absorption coefficient and the optical scattering coefficient for at least two wavelengths in the fluorescent excitation band, the optical absorption coefficient and the optical scattering coefficient for at least two wavelengths in the fluorescent emission band, and the quantum efficiency of the fluorescence from said at least two excitation wavelengths to said at least two emission wavelength, and wherein said optical absorption coefficients and said optical scattering coefficients are determined at each wavelength using at least one known function of concentration.

The invention further relates to a coloring apparatus which is arranged to add at least one fluorescent ingredient in the coloring process; determine the amount of said at least one fluorescent ingredient by using a model which describes the effect of said at least one fluorescent ingredient on the radiance transfer factor for the substrate to be colored.

The invention also relates to a coloring apparatus which is arranged to add at least one soluble ingredient into a coloring solution; expose a solid substrate to said coloring process, and thereafter separating said solid substrate from said solution; determine the addition amount of said at least one soluble ingredient to impart a desired color to the substrate by using a model which describes in combination; the adsorption or deposition or absorption of said at least one dissolved soluble ingredient onto the surface or into the material of said solid substrate in terms of a concentration of said soluble ingredient in the coloring process, and the effect of adsorbed or deposited or absorbed said at least one soluble ingredient on an optical spectral property of said solid substrate, wherein said model contains at least two terms for the at least one soluble ingredient, the terms being added or subtracted, and each of said at least two terms comprising a product of a spectral function and a function of concentration, and not all spectral functions of all terms are identical, the model generally taking the form

$$\frac{\partial p ( λ )}{\partial c} = {g}_{1} ( λ ) {f}_{1} ( c ) + {g}_{2} ( λ ) {f}_{2} ( c )$$

where p(λ) is the spectral property of the substrate, g₁(λ) and g₂(λ) are known spectral functions which are not identical, and f₁(c) and f₂(c) are known functions of concentration.

The invention also relates to a coloring apparatus which is arranged to add at least one fluorescent ingredient in the coloring process; determine the addition amount of said at least one fluorescent ingredient to impart a desired color to the substrate by using a model which describes the effect of at least said at least one fluorescent ingredient on a radiance transfer factor for a substrate to be colored; said model contains at least one term for the at least one fluorescent ingredient, the term comprising a product of a spectral transfer function and a function of concentration, the model generally taking the form

$$\frac{\partial p ( ζ , λ )}{\partial c} = g ( ζ , λ ) f ( c )$$

where p(Ξ, λ) is the radiance transfer factor of the substrate, g(Ξ, λ) is a known spectral transfer function, and f(c) is a known function of concentration.

The invention also relates to a coloring apparatus which is arranged to add at least one fluorescent ingredient in the coloring process; determine the addition amount of said at least one fluorescent; ingredient to impart a desired color to the substrate by using a model which describes the effect of at least said at least one fluorescent ingredient on a radiance transfer factor for a substrate to be colored; said model contains at least two terms for the at least one fluorescent ingredient, each term comprising a product of a spectral transfer function and a function of concentration, one spectral transfer function differs from at least one other spectral transfer function, the model generally taking the form

$$\frac{\partial p ( ζ , λ )}{\partial c} = {g}_{1} ( ζ , λ ) {f}_{1} ( c ) + {g}_{2} ( ζ , λ ) {f}_{2} ( c )$$

where p(Ξ, λ) is the radiance transfer factor of the substrate, g₁(Ξ, λ) and g₂(Ξ, λ) are known spectral transfer functions which are not identical, and f₁(c) and f₂(c) are known functions of concentration.

The invention also relates to a coloring apparatus which is arranged to add at least one fluorescent ingredient in the coloring process; determine the addition amount of said at least one fluorescent ingredient to impart a desired color to the substrate by using a model which describes the effect of at least said at least one fluorescent ingredient on a radiance transfer factor for a substrate to be colored; the radiance transfer factor being determined from: the optical absorption coefficient and the optical scattering coefficient for at least two wavelengths in the fluorescent excitation band, the optical absorption coefficient and the optical scattering coefficient for at least two wavelengths in the fluorescent emission band, and the quantum efficiency of the fluorescence from said at least two excitation wavelengths to said at least two emission wavelength, and wherein said optical absorption coefficients and said optical scattering coefficients are determined at each wavelength using at least one known function of concentration.

The preferred embodiments of the invention are disclosed in the dependent claims.

The invention is based on a model for a fluorescent ingredient that allows the energy transfer from each exciting wavelength to each emission wavelength to be taken into account in the fluorescence. The non-fluorescent part of the model can be based on for example prior art of colorant formulation using Kubelka-Munk theory. The non-fluorescent part of the model is, however, preferably based on the presented solution according to which a colorant modeling utilizes the Langmuir adsorption isotherm. In the latter the absorption band broadening effect on the excitation/absorption band of the fluor or non-fluorescent colorant can be taken into account as well as effects of aggregated FBA molecules onto the emission spectrum produced primary by monomeric FBA molecules. The coloring model utilization the Langmuir isotherm can be applied also by itself to both fluorescent and non-fluorescent ingredients.

The method and arrangement of the invention provides various advantages. The solution of the invention allows fluorescent and non-fluorescent ingredients to be modeled with precision during the coloring process and this model can be used to calculate the required change in dosage of one or more fluorescent or non-fluorescent ingredient so that the perceived color error under single or multiple illumination conditions would be minimized or even canceled.

### BRIEF DESCRIPTION OF THE DRAWINGS

In the following, the invention will be described with reference to preferred embodiments and to the accompanying drawings, in which

FIG. 1 shows the change in the radiance transfer factor β(Ξ, λ) when Ξ is Ξ=360 nm and the amount of one fluorescent ingredient changes;

FIG. 2 shows a quantum efficiency Q(Ξ, λ), where Ξ is Ξ=360 nm, when the amount of one fluorescent ingredient changes;

FIG. 3A shows a radiance transfer factor β(Ξ, λ) for a paper sample with FBA;

FIG. 3B shows a fluorescence cascade;

FIG. 4 shows a radiance transfer factor β(Ξ, λ) in a matrix form;

FIG. 5 shows a radiance transfer factor increment Δβ(Ξ, λ);

FIG. 6 shows

$$\frac{{[ D ]}_{f}}{{[ D ]}_{s}}$$

versus [D]_{f} plot of two colors and their estimate;

FIG. 7A shows a layered structure,

FIG. 7B shows a layered structure;

FIG. 8A shows a broadening effect and

FIG. 8B shows how a broadening effect can be taken into account;

FIG. 9 is a block diagram of a model for color control;

FIG. 10A shows a feedback arrangement; and

FIG. 10B is a block diagram of color control.

### DETAILED DESCRIPTION OF THE INVENTION

The solution of the invention is well suited for use in process industry, where a product manufactured in the process is to be colored. This includes sheet, film or web processes in paper, plastic and fabric industries, the invention not being, however, restricted to them.

Let us first examine matters related to color measurement. Color is conventionally expressed as colorimetric quantities having three values. Colorimetric systems in common use include for example CIE Tristimulus; CIE Chromaticity, Lightness; CIE L*a*b*; Hunter L,a,b; Hue Angle, Saturation Value and Dominant wavelength, Excitation purity, Lightness. Their calculation is explained in ASTM test method E308—95, for example.

The tristimulus values are calculated from the reflectance factor or transmittance factor of an object, using the spectral power distribution of the illuminate under which the object's color appearance is to be evaluated. Conventionally, tristimulus values are defined as integrals but are normally evaluated as finite approximations:

$$\begin{matrix}X = k {\int }_{380}^{780} R ( λ ) I S ( λ ) \overline{x} ( λ ) ⅆ λ = k {\sum }_{j = 1}^{N} {R}_{j} I {S}_{j} {\overline{x}}_{j} δλ & 1 \\ Y = k {\int }_{380}^{780} R ( λ ) I S ( λ ) \overline{y} ( λ ) ⅆ λ = k {\sum }_{j = 1}^{N} {R}_{j} I {S}_{j} {\overline{y}}_{j} δλ & 2 \\ Z = k {\int }_{380}^{780} R ( λ ) I S ( λ ) \overline{z} ( λ ) ⅆ λ = k {\sum }_{j = 1}^{N} {R}_{j} I {S}_{j} {\overline{z}}_{j} δλ & 3\end{matrix}$$

where k is a normalization factor, IS is the spectral power distribution of the illuminant, \overline{x}, \overline{y}, \overline{z}, are the standard observer functions, tabulated at uniform wavelength intervals and R(λ) is the true reflectance (or transmittance). It also holds that R(λ)IS(λ)=Φ(λ′IS) and Rⱼ|Sⱼ=Φⱼ, where Φ(λ|IS) and Φⱼ represent the total spectral radiant energy in that band leaving the surface under illumination conditions IS. The use of fluorescent ingredients is possible in the described solution because true reflectance R(λ) is replaced by the apparent reflectance factor R*(λ|IS), more preferably by the total radiance factor βτ(λ|IS) calculated for chosen illuminant IS from the radiance transfer factor β(Ξ, λ) which also accounts for the emittance on the visible wavelength λ of energy absorbed on the exciting wavelength Ξ.

Let us also briefly define metamerism. Metamerism is the tendency of two samples to match in perceived color under particular conditions of illumination and viewing, but to differ under another set of conditions. This can happen if the spectral radiances of the samples differ, but their colorimetric values are the same. Metamerism can manifest itself in several ways of which illuminant metamerism—samples match under one illuminant, but not under another, is the most interesting for fluorescent samples. Due to ambiguity in the use of the term “illuminant metamerism”, “illuminator metamerism” is introduced instead:

illuminator metamerism—spectral radiances of samples match under one illuminator, but not under another.

Evaluation of illuminator metamerism requires that the spectral radiances (or equivalently, the apparent reflectances) of specimens be measured using specific illuminators of interest.

We shall then examine the use of fluorescent ingredients in paper industry. By far the greatest usage of fluorescent agents in papermaking is of water-soluble chemicals which absorb in the near ultra-violet (250 to 400 nm) and emit in the violet-blue range (380 to 480 nm). These chemicals are variously referred to as optical brightening agents (OBA), fluorescent brightening agents (FBA), or fluorescent whitening agents (FWA). FBAs are predominantly used in the manufacture of white and high-white grades made from wood-free pulps. Almost all FBAs used in paper are derivatives of stilbene. Specialty colored grades may also contain fluorescent chemicals, but as fluorescent dyes or colorants, rather than as whiteners. These agents absorb and emit light at longer wavelength than FBAs, often emitting in the yellow-orange spectral region.

FBAs used in wet end, size press, and coating applications are chemically different. Charge densities vary, being greatest for FBAs in the least aqueous environments. FBA molecules are adsorbed at suitable sites onto the surface of fibers and fillers, and have different affinities for each substrate. The binding with fibers is generally by Van der Waals and hydrogen bonds. FBAs may be adsorbed, absorbed or deposited onto the interior as well as the exterior surfaces of fibers, depending on the fiber characteristics and degree of refining. Their concentration in process, such as dissolved soluble ingredient in the coloring solution, as well as the surface concentration of the FBA adsorbed, absorbed or deposited onto the surface of colored solid substrate can be defined by using known methods. Furthermore, the surface concentration of the monolayer and a superlayer above a monolayer on the surface of colored solid substrate can be defined, which will be discussed later. Daylight fluors have their excitation and emission bands in visible light.

Let us now take a closer look at the principles of color measurement in process industry. Modern paper mills, for example, generally rely on spectrophotometers both for on-line and laboratory measurements of color as a reflectance spectrum. These instruments usually also measure other color-related quantities, such as opacity and brightness scales (typically TAPPI, ISO or D₆₅).

Spectrophotometry uses relative measurements, and each wavelength is treated as independent of the others. A reflectance factor R(λ) is calculated for each wavelength band λ as the ratio of the reflected spectral radiant energy of sample Φ_{ref}(λ|IS) in that band to that of a white standard Φ_{std}(λ|IS) of known reflectance factor R_{std}(λ), illuminated with the same rich light source IS(λ), which contains adequate power at all measured wavelengths. An apparent reflectance spectrum R*(λ|IS) is calculated for each wavelength band λ as the ratio of the total spectral radiant energy of sample Φ(λ|IS) in that band to that of a white reference Φ_{std}(λ|IS) of known reflectance R_{std}(λ), illuminated with the same rich light source IS(λ), which contains adequate power at all visible wavelengths.

$${R}^{*} ( λ \vert I S ) = {R}_{std} ( λ ) \frac{Φ ( λ \vert I S ) d λ}{{Φ}_{std} ( λ \vert I S ) d λ} \qquad ( 4 )$$

This apparent reflectance spectrum, R*(λ|IS), is then deemed to be identical to the true reflectance spectrum, R(λ), without consideration of fluorescent effects.

$$R ( λ ) = {R}^{*} ( λ \vert I S ) ⇔ {R}_{std} ( λ ) \frac{{Φ}_{ref} ( λ \vert I S )}{{Φ}_{std} ( λ \vert I S )} = {R}_{std} ( λ ) \frac{Φ ( λ \vert I S )}{{Φ}_{std} ( λ \vert I S )} \qquad ( 5 )$$

Clearly, (5) holds only for wavelengths in which fluorescent emission is negligible, and such is an implicit condition in spectrophotometric color measurements. It is convenient for photometric instruments, since only ratios of radiances in of the same band are used, and hence absolute measurements are not required. Also, it is not necessary to know the exact energy distribution of the illuminator, provided it is stable.

In the case of fluorescent color measurement, it is not strictly valid to refer to a reflectance spectrum, but only to radiance factors. The spectrophotometrically measured apparent reflectance spectrum, R*(λ|IS), becomes dependent on the relative power distribution of the illuminator, especially the relative powers in the absorption and emission wavelength ranges. Spectrophotometers measure the combination of true reflectance with prevailing absorption-emission effects, and treat the total remitted light as if it were all reflected light. The apparent reflectance factor R*(λ|IS) of a fluorescent specimen measured by a spectrophotometer using (4) can be estimated:

$$R * ( λ \vert I S ) = R ( λ ) + \frac{{\int }_{ζ = {ζ}_{0}}^{ζ = λ = d λ} β ( {ζ}_{r} λ ) d λ I S ( ζ ) d ζ}{I S ( λ ) d λ} \qquad ( 6 )$$

where R(λ)=β(λ, λ) is reflectance factor, R*(λ|IS)≈β_{T}(λ|IS) is the total radiance factor and β(Ξ, λ) is the radiance transfer factor. For wavelengths in the emission band of the FBA, this apparent reflectance factor will exceed the true reflectance at the emission band of the fluor by a systematic variable amount, which depends on the illuminator's spectral distribution in both absorption and emission bands, as well as on the amount of fluorescence.

The Kubelka-Munk theory defines the reflectance factor R, when fluorescence is not taken into account, on the wavelength λ as follows

$$R ( λ ) = 1 + \frac{K ( λ )}{S ( λ )} - \sqrt{{( \frac{K ( λ )}{S ( λ ) + 1} )}^{2} - 1} \qquad ( 7 )$$

In the reflectance coefficient based on the Kulbelka-Munk theory the relative error is greatest at wavelengths of low and high reflectance factors, i.e. when the object to be measured is strongly or minimally absorbing at some wavelengths. Since the spectrophotometric measurements do not allow reflected radiation to be distinguished from radiation emitted in the fluorescence, the reflectance factor of an abject of measurement treated with fluorescent ingredients seems to be high (more than 1 even).

To estimate the radiance factors for conditions other than those of measurement, modifications are made to the standard spectrophotometric instruments and methods. An attempt is made to split the total measured spectral radiance into reflective and luminescent components,

Φ(λ|IS)=Φ_{R}(λ|IS)+Φ_{L}(λ|IS):

Φ_{R}(λ|IS)dλ=R(λ)IS(λ)dλ (8)

$${Φ}_{L} ( λ \vert I S ) d λ = {\int }_{ζ = {ζ}_{p}}^{ζ = λ - d λ} β ( ζ , λ ) d λ I S ( ζ ) d ζ \qquad ( 9 )$$

However, these methods are only improvements on the pure spectrophotometric method (5), but do not take full account of the physics of fluorescence, and thus are prone to variable systematic errors, due to invalidity of their basic assumptions. This type of solution is discussed in greater detail in J. Shakespeare, T. Shakespeare, “Color Measurement of Fluorescent Paper Grades”, TAPPI Proceedings, pp. 121-136, 1998, to be included herein as a reference.

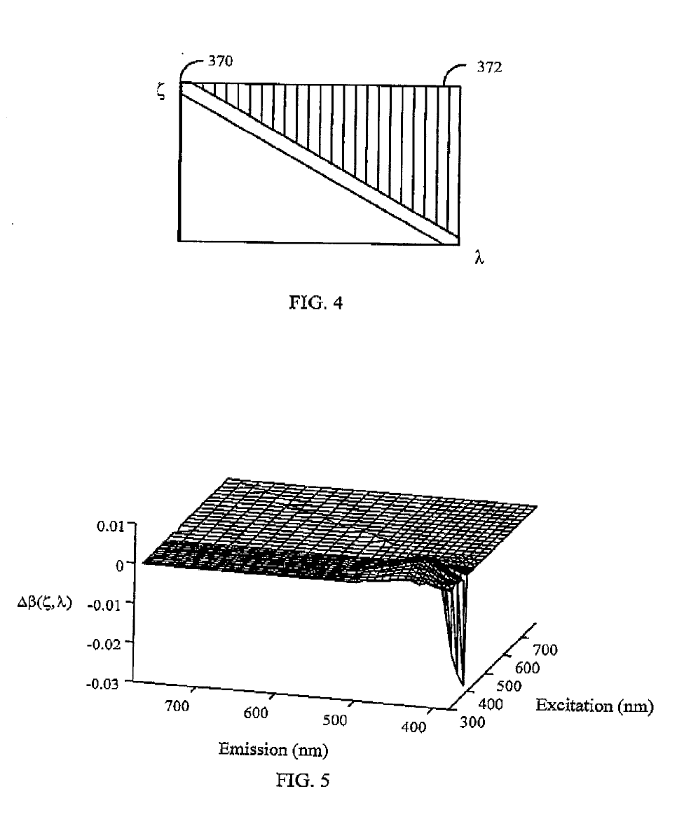

In the described solution, a model based on the Kubelka-Munk theory about colorant formulation is generated which describes the effect of at least one fluorescent ingredient cⱼ on the radiance transfer factor β(Ξ, λ), where j is an index of the substance to be added. The radiance transfer factor β(Ξ, λ) contains all values for which the emission wavelength λ is the same or longer than the exciting wavelength Ξ. The case where the detected wavelength λ is the same as the exciting wavelength Ξ can be omitted and the luminescence radiance transfer factor β_{L}(Ξ, λ) can be formed (see FIG. 4). The luminescence radiance transfer factor β_{L}(Ξ, λ) for the emission band of fluorescence λ>Ξ is expressed as:

$${β}_{L} ( ζ , λ ) = \frac{{K}_{F} ( ζ ) Q ( ζ , λ )}{2 ( N ( λ ) + N ( ζ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} ) \approx \frac{F ( ζ , λ )}{2 ( N ( λ ) + N ( ζ ) )} ( 2 + \frac{K ( λ )}{S ( ζ )} - \frac{N ( ζ )}{S ( ζ )} ) ( 2 + \frac{K ( λ )}{S ( λ )} - \frac{N ( λ )}{S ( λ )} ) \qquad ( 10 )$$

where N(x)=\sqrt{K(x)²+2K(x)S(x)}. K_{F}(Ξ) is the effective absorption coefficient in principle calculated as K_{F}(Ξ)=K_{c}(Ξ)−Kₛ(Ξ), K_{c}(Ξ) is absorption coefficient for a colored substrate, Kₛ(Ξ) is absorption coefficient for a base substrate, x can be replaced by variable Ξ or λ, the variable Ξ represents the wavelength of the exciting radiance and λ the detected wavelength, K(λ) and K(Ξ) are absorption coefficients, S(λ) and S(Ξ) are scattering coefficients, Q(Ξ, λ) is a quantum efficiency coefficient and F(Ξ, λ) is a term describing the fluorescence. Both optical absorption and scattering coefficients, K and S, are dependent on of the concentration of the colorant on the colored solid substrate. The variable Ξ represents the wavelength of the exciting radiance and λ the detected wavelength used in radiance transfer factor measurements. Since the energy transfer from each exciting wavelength to each emission wavelength is taken into account in the coloring model for a fluorescent ingredient, it is more comprehensible and useful to use the luminescence radiance transfer factor β_{L}(Ξ, λ) as a modeled quantity than radiance transfer factor β(Ξ, λ). The ingredient may be a fluorescent substrate, such as furnish containing FBA, into which same or other fluorescent ingredients are added, or the ingredient may be a fluorescent ingredient, such as fluorescent colorant that is added to the coloring process. In paper industry, the furnish, the paper pulp/mass or the paper web is the substrate. Instead of using the absorption coefficient K and the scattering coefficient S that are usually calculated from single sheet and stack measurements, reflectance factor R(λ) measured similarly can be used The formula (10) may also be expressed based on reflectance factor R(λ) estimates for terms of absorption and scattering coefficients or their combinations, however containing the term for quantum efficiency coefficient Q(Ξ, λ) or similar term as F(Ξ, λ) describing the fluorescence.

The formula (10) is important for the presented coloring model. The quantum efficiency coefficient Q(Ξ, λ) can be solved from the formula (10) and estimated, when effective absorption coefficient K_{F}, absorption coefficient K and scattering coefficient S and radiance transfer factors β(Ξ, λ) are known, (for example based on measured β(Ξ, λ) values from a set of samples determining the effect of a varying amount of fluorescent ingredient on the set of coloring conditions). Based on that, a coloring model as described in formula (10) for determining the effect of a fluorescent ingredient on a spectral property can be accomplished, such as radiance transfer factor and/or apparent reflectance factor or total radiance factor.

The coloring model given in formula (10) can be extended to contain also the diagonal of radiance transfer factor β(Ξ, λ) having the meaning of reflectance factor caused by fluorescent ingredient absorption so that β(Ξ, λ)=β(λ, λ)+β_{L}(Ξ, λ). The β(λ, λ) term of the coloring model can be modeled for example using prior art colorant formulation based Kubelka-Munk theory or utilizing Langmuir isotherm as will be described later.

On each wavelength, the absorption coefficient K, the scattering coefficient and the fluorescence coefficient F can be shown in the form of a power series, the factors to be summed being associated with different orders i of the differentials

$$\frac{{\partial }^{i}}{\partial {c}_{j}^{i}}$$

of a fluorescent colorant. The absorption coefficient K, for example, is then expressed as

$$K ( λ ) = {K}_{0} ( λ ) + {\sum }_{j = 1}^{M} \frac{\partial K ( λ )}{\partial {c}_{j}} Δ {c}_{j} + {\sum }_{j = 1}^{M} \frac{{\partial }^{2} K ( λ )}{\partial {c}_{j}^{2}} {Δ}^{2} {c}_{j} + \qquad ( 11 )$$

where K₀(λ) represents the absorption coefficient of the substrate serving as one ingredient. The factors of the first order in the power series can only be taken into account. The absorption coefficient K on the wavelength λ being then expressed as

$$K ( λ ) = {K}_{0} ( λ ) + {\sum }_{j = 1}^{M} \frac{\partial K ( λ )}{\partial {c}_{j}} Δ {c}_{j} \qquad ( 12 )$$

where K₀(λ) represents the absorption coefficient of the object to be measured, before the adding Δcⱼ of the fluorescent or non-fluorescent ingredient. The scattering coefficient S is expressed as

$$S ( λ ) = {S}_{0} ( λ ) + {\sum }_{j = 1}^{M} \frac{\partial S ( λ )}{\partial {c}_{j}} Δ {c}_{j} \qquad ( 13 )$$

where S₀(λ) represents the scattering coefficient of the object to be measured, before the adding Δcⱼ of the fluorescent or non-fluorescent ingredient. The term describing the fluorescence F, in turn, is estimated as

F(Ξ, λ)≈K_{F}(Ξ)Q(Ξ, λ) (14)

where the fluorescent coefficient F is a combination of the effective absorption coefficient K_{F} and quantum efficiency Q(Ξ, λ) expressed as F(Ξ, λ)≈K_{F}(Ξ)Q(Ξ, λ) and the differential of the fluorescent coefficient F with respect to a concentration c of an ingredient j is

$$\frac{\partial F ( ζ , λ )}{\partial {c}_{j}} \approx \frac{\partial {K}_{F} ( ζ ) Q ( ζ , λ )}{\partial {c}_{j}} \qquad ( 15 )$$

where F₀(λ) represents the fluorescence coefficient of the object to be measured, before the adding Δcⱼ of the fluorescent ingredient. The formula (15) can also be expressed as

$$\frac{\partial F ( ζ , λ )}{\partial {c}_{j}} \approx \frac{\partial {K}_{F} ( ζ ) Q ( ζ , λ )}{\partial {c}_{j}} \approx \frac{\partial {β}_{L} ( ζ \vert I S )}{\partial {c}_{j}} .$$

The absorbed energy of the fluorescent exciting radiance of a fluorescent ingredient is transferred to the energy of the emitting radiance, where the quantum efficiency coefficient Q(Ξ, λ) represents the efficiency of the transfer.

For the extent of change in the radiance transfer factor to be calculated as a function of the change in the amount of the ingredient to be added, expressed as

$$Δβ ( ζ , λ ) = \frac{\partial β ( ζ , λ )}{\partial {c}_{j}} Δ {c}_{j} , \qquad ( 16 )$$

where Δcⱼ represents the change in the amount of the fluorescent ingredient added and data on the ratio

$$\frac{\partial S}{\partial {c}_{j}}$$

of the change in the value of the scattering coefficient to the change in the colorant j; on the ratio

$$\frac{\partial K}{\partial {c}_{j}}$$

of the change in the value of the absorption coefficient to the change in the colorant j; and on the ratio ∂F/∂cⱼ of the change in the fluorescence factor to the change in the colorant is available. In the formula (16) radiance transfer factor β(Ξ, λ) can be replaced by luminescence radiance transfer factor β_{L}(Ξ, λ). These values can be determined with at least two measurements. The measurements can be either taken from known reference samples, or they can be made by applying the principle of trial and error, in which case the coefficients S, K, K_{F} and Q(Ξ, λ) (or F) of the substrate to be colored are measured and a fluorescent ingredient is added into the substrate to be colored. The coefficients S, K and F are then measured again to see the change caused by the fluorescent ingredient in the object to be measured. This way information about the operation of the coloring process can be stored into the coloring model and used to continuously improve the coloring process.

The quantum efficiency coefficient Q(Ξ, λ) can be calculated theoretically on the basis of material physics and chemistry, or it can be determined using measurements of known samples.

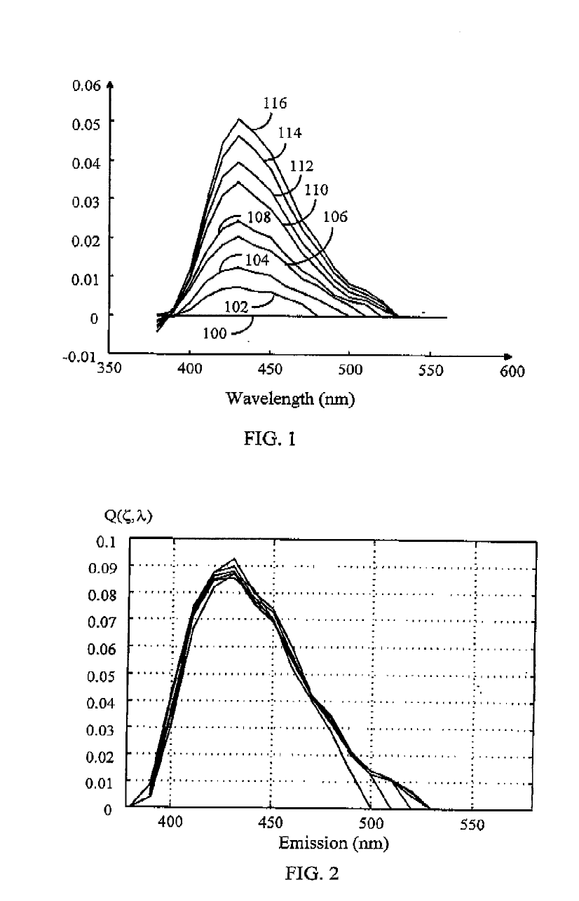

An example of how a change in the amount of one fluorescent ingredient changes the radiance transfer factor β(Ξ, λ) is given in FIG. 1 where the exciting wavelength Ξ is 360 nm. The vertical axis represents the radiance transfer factor β(Ξ, λ) value and the horizontal axis the wavelength of the radiance emitted in the fluorescence. In FIG. 1 the fluorescent ingredient Tinopal ABP liquid has been added into pulp. In curve 100, 0 kg/t of the fluorescent ingredient (Tinopal ASP liquid) has been added, its amount being 0.5988 kg/t in curve 102, 1.1976 kg/t in curve 104, 2.3952 kg/t in curve 106, 3.5928 kg/t in curve 108, 5.9880 kg/t in curve 110, 9.6808 kg/t in curve 112, 14.9701 kg/t in curve 114 and 17.9641 kg/t in curve 116. This shows that the values of the radiance transfer factor λ(360, λ) grow steadily as the fluorescent ingredient is added. As the amount of the fluorescent ingredient increases, the top value moves slightly towards a longer wavelength, due to existence of FBA dimers. When the radiance transfer factors of samples are known, it is possible to determine the color of the sample as β_{T}(λ|IS) about which the color space values can be calculated, also the parameters in the coloring model given in formula (10) can be estimated.

The quantum efficiency Q(Ξ, λ) is shown in FIG. 2. The quantum efficiency Q(Ξ, λ) represents the efficiency of the transfer of the radiance intensity from the exciting wavelength Ξ to the fluorescent emitting wavelength λ. In FIG. 2 the exciting wavelength Ξ is Ξ=360 nm. The vertical axis represents the quantum efficiency value and the horizontal axis the fluorescent emitting wavelength. The different curves show the values of measurement when 1, 2, 4, 8 and 16 kg/t, respectively, of the fluorescent ingredient is added into the paper. The fluorescent ingredient used is FBA on furnish (Leucophor AL liquid in dry fiber). Usually the quantum efficiency Q(Ξ, λ) does not change much with the amount of the fluorescent ingredient, but is clearly excitation/emission wavelength dependent. The concentration dependency of the quantum efficiency Q can be modeled in principle such as:

$$\frac{\partial p ( ζ , λ )}{\partial c} = {g}_{1} ( ζ , λ ) f ( c ) ,$$

where p(Ξ, λ) is the radiance transfer factor of the substrate, g(Ξ, λ) is a known spectral transfer function, and f(c) is a known function of concentration.

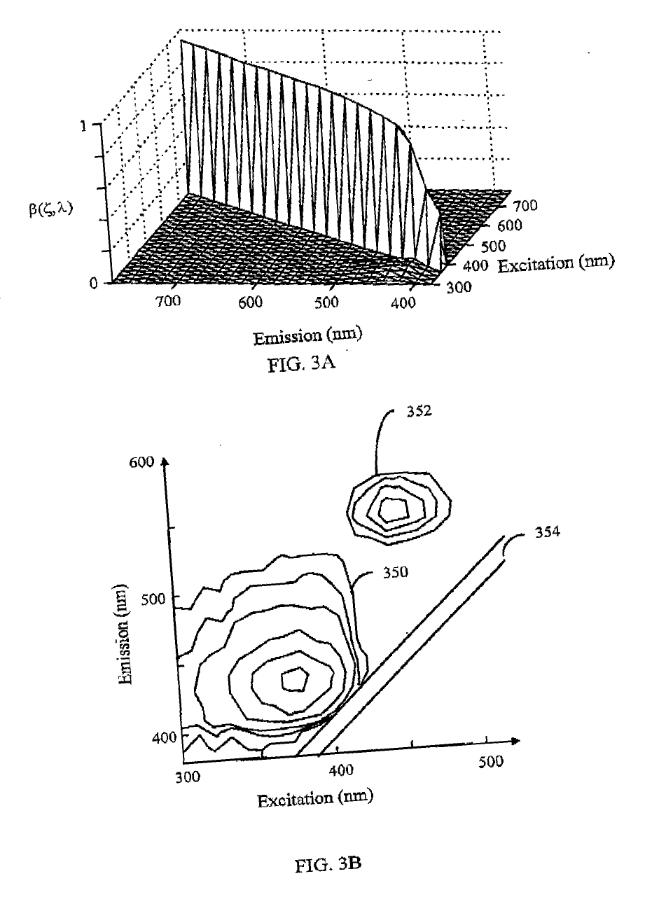

In the described coloring model, the quantum efficiency Q(Ξ, λ) represents the transfer efficiency of the absorbed intensity by fluorescent ingredient of at least two different exciting wavelengths Ξ₁ and Ξ₂ to different wavelengths of the emitting radiance. For this reason the quantum efficiency Q(Ξ, λ) can be shown, for calculation purposes, preferably as an M×N matrix where M represents the number of elements on the exciting wavelength and N the number of elements on the emitting wavelength. For example, when two different Q(Ξ, λ) values for two emitting wavelengths (N=2) are determined on two exciting wavelengths (M=3), a dependency between the intensities can be formulated:

$$[ \begin{matrix}{I}_{λ 1} \\ {I}_{λ2} \\ {I}_{λ3}\end{matrix} ] = [ \begin{matrix}{Q}_{11} & {Q}_{12} \\ {Q}_{21} & {Q}_{22} \\ {Q}_{31} & {Q}_{32}\end{matrix} ] [ \begin{matrix}{I}_{ζ1} \\ {I}_{ζ2}\end{matrix} ] \qquad ( 17 )$$

where I_{λ1} represents the intensity on an emitting wavelength λ₁, I_{λ2} the intensity on an emitting wavelength λ₂, I_{λ3} the intensity on an emitting wavelength λ₃, I_{Ξ1} the intensity on an exciting wavelength Ξ₁, I_{Ξ2} the intensity on an exciting wavelength Ξ₂, Q(Ξ, λ) matrix elements Q₁₁-Q₃₂ representing the efficiency of the transfer. Correspondingly, the fluorescence factor F can also be shown as an M×N matrix, the Q(Ξ, λ) and F matrices thus both corresponding to FIGS. 3A and 3B. In the described coloring model, the luminescence radiance transfer factor—β_{L}(Ξ, λ) thus depends on effective absorption coefficient K_{F}, the absorption coefficient K, the scattering coefficient S and the fluorescence coefficient F as described above, and the differential of the luminescence radiance transfer factor β_{L}(Ξ, λ) with respect to the added fluorescent ingredient depends on the differential of the effective absorption coefficient K_{F}, the absorption coefficient K, the scattering coefficient S and the quantum efficiency Q(Ξ, λ) expressed as

$$\frac{\partial {β}_{L} ( ζ , λ )}{\partial {c}_{j}} = \frac{\partial }{\partial {c}_{j}} \{ {K}_{F} , K , S , Q ( ζ , λ ) \} \qquad ( 18 )$$

FIG. 3A shows the radiance transfer β(Ξ, λ) for a paper sample with FBA, measured using prior art measurement method, with commercial instrument Labpshere's BFC-450. Fluorescence is a broad feature with excitation near 350 nm and emission near 440 nm. The sharp diagonal ridge (at Ξ=λ, β(λ, λ)) is due to the true reflectance R(λ) of the sample.

FIG. 3B shows a principle of a fluorescence cascade. When both FBAs and fluorescent colorants are present, fluorescent cascades can occur. FBA's contour map of radiance transfer factor is represented by a curve 350 and the fluorescent colorant's contour map of the radiance transfer factor as curve 352. A straight line 354 shows the factor for the true reflectance from the object to be measured. If a fluorescent dye has an absorption band which overlaps the emission band of the FBA, then some of the light emitted by the FBA may in turn be absorbed by the fluorescent dye and re-emitted in the fluorescent dye's emission band. When the exciting wavelength is about 375 nm, for example, FBA emits fairly efficiently on the wavelength 450 nm. The fluorescent colorant, in turn, absorbs well 450 nm radiance and emits about 550 nm radiance. Fluorescent cascades are a special case of absorption in an emission band. A fluorescent cascade changes ∂β(Ξ, λ)/∂c in a complex way, extending it to longer emission wavelengths, and reducing its original emission amplitudes. In principle, a deliberate fluorescent cascade may be beneficial, in that the FBA is boosting the available light in the absorption band of the fluorescent dye. In practice, fluorescent cascades are often problematic. Known instruments do not provide a means of reliably measuring such effects, and hence coloring processes with fluorescent cascades are difficult to control. However, the present solution for the coloring model allows also cascades to be used in the coloring process, when the measurement related to them can be made.

FIG. 4 shows the matrix form of the radiance transfer factor β(Ξ, λ). The matrix contains the measured values that are presented in FIGS. 3A and 3B in digital form. Each column corresponds to an instrumental excitation wavelength interval and each row corresponds to an instrumental emission wavelength interval. Radiance transfer factor β(Ξ, λ) can be divided into two sections wherein the first section 370 corresponds to the reflectance factor β(λ,λ)=R(λ) and the second section 372 called luminescence radiance transfer factor β_{L}(Ξ, λ) includes the rest of the values where λ>Ξ. Radiance transfer factor β(Ξ, λ) can be measured using for example commercial instruments like Labsphere BFC-450 and Minolta CM3800. Total radiance factor β_{T}(λ|IS) can be calculated from the matrix formed by the measurement

$$instruments as follows {β}_{T} ( λ \vert I S ) = \frac{{\sum }_{i = {ζ}_{0}}^{ζ} β ( ζ , λ ) I S ( ζ ) δζ}{I S ( λ ) δλ} . \qquad ( 19 )$$

FIG. 5 shows the radiance transfer increment Δβ(Ξ, λ). The radiance transfer increment Δβ(Ξ, λ) is determined by measuring first the object to be measured, such as paper, before the fluorescent ingredient is added, after which an amount of C₂ of the fluorescent ingredient is added into the object to be measured, and then the object to be measured is measured again. The amounts C₁ and C₂ are usually given as changes in concentration. Note that the starting amount C₁ may not be zero, i.e. C₁≢0 kg/t. It is also possible to carry out a plurality of measurements, in which case the magnitude of the radiance transfer increment can be determined on the basis of the amounts of a plurality of different fluorescent ingredients. In the measurement shown in FIG. 5, an amount of C₂=7 kg/t of the fluorescent ingredient is added into uncolored paper furnish. Consequently, there are at least two test measurements that can be used to determine the change in the radiance transfer factor with respect to the change

$$\frac{{β}_{2} ( ζ , λ ) - {β}_{1} ( ζ , λ )}{{C}_{2} - {C}_{1}}$$

in the amount of the fluorescent ingredient. The measurement results thus obtained can be changed in the coloring model to a differential form expressed as

$$\frac{{β}_{2} ( ζ , λ ) - {β}_{1} ( ζ , λ )}{{C}_{2} - {C}_{1}} \approx \frac{\partial β ( ζ , λ )}{\partial {c}_{j}} .$$

Usually quantum efficiency coefficient Q(Ξ, λ) can be calculated using the formula (10).

Adding a fluorescent ingredient to a substrate representing the object to be measured changes its luminescence radiance transfer factor β_{L}(Ξ, λ) and β(Ξ, λ) at least on the fluorescent ingredients excitation band. At low dosage rates, the change can be approximated by a normalized radiance transfer response function

$$\frac{\partial β}{\partial {c}_{j}}$$

scaled by the change in ingredient's concentration Δc in the substrate:

$$\begin{matrix}Δ {β}_{L} ( ζ , λ ) = \frac{\partial {β}_{L} ( ζ , λ )}{\partial {c}_{j}} {Δc}_{j} , & ( 20 ) \\ where \frac{\partial {β}_{L} ( ζ , λ )}{\partial {c}_{j}} is & \\ \frac{\frac{\partial {β}_{L} ( ζ , λ )}{\partial {c}_{j}} = \partial \{ \frac{{K}_{F} Q ( ζ , λ )}{2 ( N ( λ ) + N ( ζ ) )} ( 2 + \frac{K ( ζ )}{S ( ζ )} - \frac{N ( ζ )}{S ( λ )} ) ( 2 + \frac{K ( λ )}{S ( λ )} - \frac{N ( λ )}{S ( λ )} \}}{\partial {c}_{j}} & ( 21 )\end{matrix}$$

Each fluorescent ingredient cⱼ causes a different radiance transfer response

$$\frac{\partial β}{\partial {c}_{j}} ,$$

typically with one or more single absorption maxima in ultra-violet. The partial differential of the radiance transfer factor

$$\frac{\partial β ( ζ , λ )}{\partial {c}_{j}}$$

is

$$\frac{\partial β ( ζ , λ )}{\partial {c}_{j}} = \frac{\partial β ( λ , λ )}{\partial {c}_{j}} + \frac{\partial {β}_{L} ( ζ , λ )}{\partial {c}_{j}} \qquad ( 22 )$$

The term β(λ, λ) in the coloring model can be modeled for example using prior art colorant formulation based on Kubelka-Munk theory or utilizing Langmuir isotherm as will be discussed next, for both fluorescent and non-fluorescent colorants or ingredients. A non-fluorescent colorant can be understood as a special case of implementation of the coloring model.

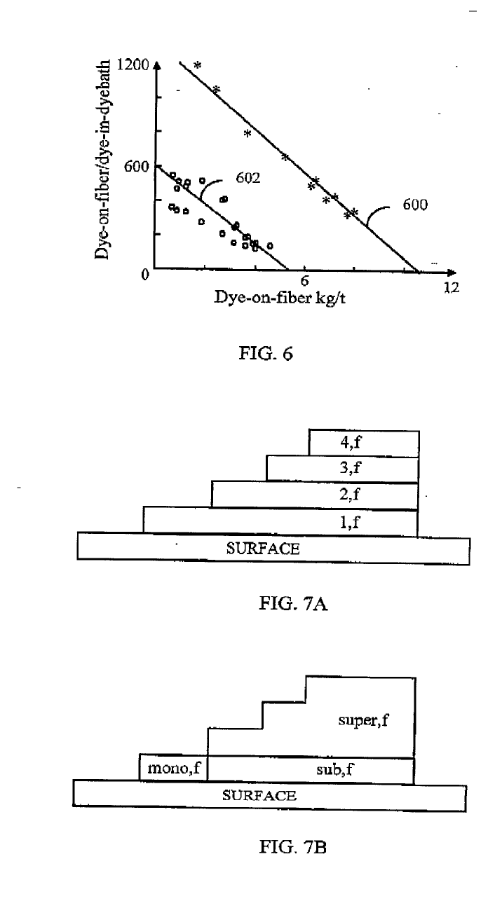

In batch process, a soluble ingredient is added into a coloring solution wherein it dissolves. Then a solid substrate is exposed to the coloring solution, and thereafter the solid substrate with a desired color is separated from said solution. In batch and feedforward processes, several factors have an effect on the coloring. An adsorbed, absorbed or deposited dissolved soluble ingredient, such as a colorant molecule onto the surface or into the absorbent such as a fiber or on any solid absorbs electromagnetic radiation in discrete quantities characteristic to the type of the colorant molecule. This merges the adsorption end the absorption processes. As an example, the amount of dye-on-adsorbent where adsorbents are fibers was determined on the basis of backwater analyses for sheets dyed with Pergasol Yellow RN Powder and Pergasol Turquoise R Powder and it was modeled on the basis of monolayer Langmuir isotherm. FIG. 6 shows

$$\frac{{[ D ]}_{f}}{{[ D ]}_{s}}$$

versus [D]_{f} plot of the Yellow coloring 600 and Turquoise coloring 602 and their estimate where [D]_{f} represents the concentration of dye-on-fiber and [D]ₛ represents the concentration of dye in dyebath. If the coloring follows a Langmuir isotherm the saturation value of a dye can be estimated from fitting

$$\frac{{[ D ]}_{f}}{{[ D ]}_{s}}$$

versus [D]_{f} as a straight line whose intercept on the [D]_{f} axis is the saturation value of dye-on-the-fiber [S]_{f}. The saturation concentration is [S]_{f}=10.6 kg/T for Yellow dye and [S]_{f}=5.4 kg/T for Turquoise at these dyeing conditions.

Thus the change for example in the absorption coefficient K(λ)−Kₛ(λ) of a substrate caused by the dyeing will follow the Langmuir isotherm. Other adsorption isotherms can also be used, such as Freundlich and BET. Langmuir isotherm has been discussed in greater detail for example in D. D. Do, Adsorption Analysis, Equilibria and Kinetics, vol. 2, Chemical Engineering, Imperial College press, p. 13-18, 191-197, 1998.

A linear approximation describing the absorption coefficient K_{c}(λ), scattering coefficient S_{c}(λ) and fluorescence coefficient F_{c}(λ) at concentration c of dye-on-absorbent can be formed as:

$${K}_{c} ( λ ) = {K}_{s} ( λ ) + ( {K}_{∞} ( λ ) - {K}_{s} ( λ ) ) k \frac{c}{1 + k c} , \\ {S}_{c} ( λ ) = {S}_{s} ( λ ) + ( {S}_{∞} ( λ ) - {S}_{s} ( λ ) ) \frac{k c}{1 + k c} and \\ {F}_{c} ( ζ , λ ) = {F}_{s} ( ζ , λ ) + ( {F}_{∞} ( ζ , λ ) - {F}_{s} ( ζ , λ ) ) k \frac{c}{1 + k c} , \qquad ( 23 )$$

where Kₛ(λ), Sₛ(λ) and Fₛ(Ξ, λ) are coefficients of the base substrate (for example a sheet of paper) to be colored, K_{∞}(λ), S_{∞}(λ) and F_{∞}(Ξ, λ) are coefficients of the colored substrate at the adsorption maximum or near it, k is the adsorption affinity constant and c is the concentration of the dye-on-absorbent. In the coloring processes in paper industry the concentration of the dye-on-absorbent often corresponds to the concentration in the dyebath. The concentration in the dyebath is known. The absorption coefficient K_{c}(λ), scattering coefficient S_{c}(λ) and fluorescence coefficient Fₒ(Ξ, λ) can be used to determine the radiance transfer factor β(Ξ, λ) and the apparent reflectance factor R*(λ|IS). From radiance transfer factor β(Ξ, λ) the total radiance factor β_{T}(λ|IS) can be calculated, and it allows the color of the substrate to be colored to be determined in the desired color space. Instead of using absorption coefficient K_{c}(λ), scattering coefficient S_{c}(λ) and fluorescence coefficient F_{c}(Ξ, λ) the modeling can be also based on reflectance factor R_{c}(λ) or the apparent reflectance factor R*(λ, IS). The reflectance factor R_{c}(λ) can be expressed as:

$${R}_{o} ( λ ) = {R}_{s} ( λ ) + ( {R}_{∞} ( λ ) - {R}_{s} ( λ ) ) k \frac{c}{1 + k c} \qquad ( 24 )$$

When effect of fluorescent ingredient is modeled using the apparent reflectance factor the estimated coloring model is dependent on the used spectrophotometric instruments, especially its illuminator. Different versions of the formulas (23) and (24) can be made or by making the formulas (25) and (26) to adapt to various process conditions especially taking into account the aggregate formation. In these cases the concentration c corresponds to the adding Δc=c₂−c₁ of ingredient, c₂ being c₂=c and c₁ corresponding to a situation where the addition of colorant starts. The ingredient added may be fluorescent or non-fluorescent.

Since dyes and particularly direct anionic dyes have a high tendency to form aggregates, a monolayer model is not accurate enough. Thus an improved coloring model utilizing Langmuir isotherm was constructed. The coloring model is based on a multilayered structure with the following assumptions:

the first adsorbed layer of molecules appears as a homogenous surface for adsorption of a second layer of molecules, and thereafter subsequent layers j and j+1;

excitation and adsorption energies for adsorption onto the second layer differ from those of the first layer; for the second and the subsequent layers these energies are assumed to be the same;

the saturation concentration for the second and the subsequent layers is equal to the concentration of the layer immediately beneath (i.e. the saturation concentration for layer j is [Dⱼ₋₁]_{f}).

Adsorption r of layer j onto layer j−1 can be modeled as follows:

r_{ads,j}=k_{ads,j}[D]ₛ([Dⱼ₋₁]_{f}−[Dⱼ]_{f})

r_{des,j}=k_{des,j}[Dⱼ]_{f}−[Dⱼ₊₁]_{f} (25)

where r_{ads,j} is adsorption and r_{des,j}—is desorption rate for the particular set of dyeing conditions, [Dⱼ]_{f} is the surface concentration of the j^{th} adsorbed layer and [Dⱼ₊₁] is the surface concentration of the (j+1)^{lh} adsorbed layer, and where [D₀]ᵣ=[S]_{f}.

In FIGS. 7A and 7B, a layered structure is shown. The first adsorbed layer 1, f and the subsequent layers 2, f, 3, f, . . . form regions with monolayer coverage mono, f and multilayer coverage multi, f, where multilayer is composed of sublayer sub, f and superlayer super, f. The total surface concentration [Dₜₒₜₐₗ]_{f} of adsorbed dye can be derived to be as follows:

$${[ {D}_{total} ]}_{f} = {\sum }_{j = 1}^{n} {[ {D}_{j} ]}_{f} = {[ {D}_{1} ]}_{f} ( 1 + \frac{{[ {D}_{2} ]}_{f}}{{[ {D}_{1} ]}_{f}} ( 1 + … ( 1 + \frac{{[ {D}_{n} ]}_{f}}{{[ {D}_{n - 1} ]}_{f}} ) ) ) \qquad ( 26 )$$

The multilayer surface concentration [Dₘᵤₗₜᵢ]_{f} is:

$${[ {D}_{multi} ]}_{f} = {2 [ {D}_{2} ]}_{f} + {\sum }_{j = 3}^{n} {[ {D}_{j} ]}_{f} \qquad ( 27 )$$

The superlayer surface concentration [Dₛᵤₚₑᵣ]_{f} (all layers not in contact with the substrate) is:

$${[ {D}_{super} ]}_{f} = {\sum }_{j = 2}^{n} {[ {D}_{j} ]}_{f} \qquad ( 28 )$$

The monolayer surface concentration [Dₘₒₙₒ]_{f} (in contact only with the substrate) is:

[Dₘₒₙₒ]_{f}=[D₁]_{f}−[D₂]_{f} (29)

The sublayer surface concentration [D_{sub}]_{f} (in contact with the substrate and the superlayer) is:

[D_{sub}]_{f}=[D₂]_{f}. (30)

Because anionic direct dyes have a high tendency to aggregate, they cause the absorption band broadening. The broadening of the absorption band is due to interaction between the adsorbed molecules. Because of that, different concentrations of a dye produce different spectral responses of a substrate. The surface concentration of superlayer adsorbate [D^{super}]_{f} can be taken as a suitable proxy measure of the amount of adsorbed dye molecules interacting with other adsorbed molecules. This proxy concentration can be used to model the broadening phenomena in a spectral property.

Now an approximation describing for example the reflectance R_{c}(λ), transmittance T_{c}(λ), and total radiance factor β_{T}(λ|IS), and the coefficients of absorption K_{c}(λ) scattering S_{c}(λ) and fluorescence F_{c}(λ) in a concentration of [Dₜₒₜₐₗ]_{f} of dye-on-absorbent can be formed for example as:

$$\begin{matrix}{R}_{c} ( λ ) = {R}_{s} ( λ ) + {R}_{1} ( λ ) \frac{{q [ {D}_{total} ]}_{f}}{1 + {q [ {D}_{total} ]}_{f}} + {R}_{2} ( λ ) \frac{{p [ {D}_{super} ]}_{f}}{1 + {p [ {D}_{super} ]}_{f}} & ( 31 ) \\ {T}_{c} ( λ ) = {T}_{s} ( λ ) + {T}_{1} ( λ ) \frac{{q [ {D}_{total} ]}_{f}}{1 + {q [ {D}_{total} ]}_{f}} + {T}_{2} ( λ ) \frac{{p [ {D}_{super} ]}_{f}}{1 + {p [ {D}_{super} ]}_{f}} & ( 32 ) \\ {{β}_{T} ( λ \vert I S )}_{c} = {{β}_{T} ( λ \vert I S )}_{s} + {{β}_{T} ( λ \vert I S )}_{1} \frac{{q [ {D}_{total} ]}_{f}}{1 + {q [ {D}_{total} ]}_{f}} + {{β}_{T} ( λ \vert I S )}_{2} \frac{{p [ {D}_{super} ]}_{f}}{1 + {p [ {D}_{super} ]}_{f}} & ( 33 ) \\ β ( ζ , λ ) = {β ( ζ , λ )}_{s} + {β ( ζ , λ )}_{1} \frac{{q [ {D}_{total} ]}_{f}}{1 + {q [ {D}_{total} ]}_{f}} + {β ( ζ , λ )}_{2} \frac{{p [ {D}_{super} ]}_{f}}{1 + {p [ {D}_{super} ]}_{f}} & ( 34 ) \\ {K}_{c} ( λ ) = {K}_{s} ( λ ) + {K}_{1} ( λ ) \frac{{q [ {D}_{total} ]}_{f}}{1 + {q [ {D}_{total} ]}_{f}} + {K}_{2} ( λ ) \frac{{p [ {D}_{super} ]}_{f}}{1 + {p [ {D}_{super} ]}_{f}} & ( 35 ) \\ {S}_{c} ( λ ) = {S}_{s} ( λ ) + {S}_{1} ( λ ) \frac{{q [ {D}_{total} ]}_{f}}{1 + {q [ {D}_{total} ]}_{f}} + {S}_{2} ( λ ) \frac{{p [ {D}_{super} ]}_{f}}{1 + {p [ {D}_{super} ]}_{f}} & ( 36 ) \\ {F}_{c} ( λ ) = {F}_{s} ( λ ) + {F}_{1} ( λ ) \frac{{q [ {D}_{total} ]}_{f}}{1 + {q [ {D}_{total} ]}_{f}} + {F}_{2} ( λ ) \frac{{p [ {D}_{super} ]}_{f}}{1 + {p [ {D}_{super} ]}_{f}} & ( 37 )\end{matrix}$$

where R₂(λ)=R_{∞,a}(λ)=Rₛ(λ), T₂(λ)=T_{∞,a}(λ)=Tₛ(λ), β_{T}(λ|IS)₂=β_{T}(λ|IS)_{∞,a}−β_{T}(λ|IS)ₛ, β(Ξ, λ)=β_{∞,a}(Ξ, λ)−β(Ξ, λ)ₛ, K₂(λ)=K_{∞,a}(λ)−Kₛ(λ), S₂(λ))=S_{∞,a}(λ)−Sₛ(λ) and F₂(λ)=F_{∞,a}(λ)−Fₛ(λ), K_{∞,a}(λ), R_{∞,a}(λ), T_{∞,B}(λ), β_{T}(λ|IS)_{∞,a,} β_{∞,a}(Ξ, λ), S_{∞, a}(λ) and F_{∞,a}(λ) include the absorption band broadening effect on the absorption coefficient at the adsorption maximum, q and p being probability constants of a photon to be absorbed by the dye molecule in aP1 layers total,f and in the superlayer super, f, respectively. F₁(λ) is F₁(λ)=F_{∞}(λ)−Fₛ(λ), S₁(λ) is S₁(λ)=S_{∞}(λ)−Sₛ(λ), K₁(λ) is K₁(λ)=K_{∞}(λ)−K₃(λ), T₁(λ) is T₁(λ)=T_{∞}(λ)−Tₛ(λ) and R₁(λ) is R₁(λ)=R_{∞}(λ)−Rₛ(λ), where F_{∞}(λ), S_{∞}(λ), K_{∞}(λ), T_{∞}(λ) and R_{∞}(λ) are coefficients of colored substrate at the adsorption maximum. Fₛ(λ), Sₛ(λ), Kₛ(λ), Tₛ(λ) and Rₛ(λ) are coefficients of the base substrate and F₁(λ) and F₂(λ) are known spectral functions of fluorescence and they are not identical. S₁(λ) and S₂(λ) are known spectral functions of optical scattering coefficients and they are not identical. K₁(λ) and K₂(λ) are known spectral functions of optical absorption coefficients and they are not identical. R₁(λ) and R₂(λ) are known spectral functions of reflectance factors and they are not identical. T₁(λ) and T₂(λ) are known spectral functions of transmittance factors and they are not identical. β_{T} (λ|IS)₁ and β_{T} (λ|IS)₂ are known spectral functions of total radiance factors and they are not identical. β(Ξ, λ)₁ and β(Ξ, λ)₂ are known spectral functions of radiance transfer factors and they are not identical. In each above cases the subsript_1 for a spectral quantity describe for example the effect for an “average” known spectral function caused by the known function of concentration, such as [Dₜₒₜₐₗ]_{f}, and the subscript 2 for a spectral quantity describes for example the effect for an “average” known spectral function caused by the known function of concentration, such as [Dₛᵤₚₑᵣ]_{f} on measured spectral quantity, for example effect of absorption band broadening. Instead of Dₜₒₜₐₗ Dₘₒₙₒ or D₁ can be used. When Dₘₒₙₒ is used Dₛᵤₚₑᵣ can be replaced by Dₘᵤₗₜᵢ but when D₁ is used Dₛᵤₚₑᵣ remains. These formulas take into account the absorption band broadening in the excitation band of the fluorescent dye and the greening effect that shifts the excitation band towards longer wavelengths. These formulas also take into the account the absorption band broadening in absorption band of non-fluorescent colorant.

An optical property P_{c} can be expressed in a general form as

$${P}_{c} ( λ ) = {P}_{s} ( λ ) + {P}_{1} ( λ ) \frac{{q [ {D}_{total} ]}_{f}}{1 + {q [ {D}_{total} ]}_{f}} + {P}_{2} ( λ ) \frac{{p [ {D}_{super} ]}_{f}}{1 + {p [ {D}_{super} ]}_{f}} \qquad ( 38 )$$

where the optical property may be the reflectance R_{c}(λ), transmittance T_{c}(λ), total radiance factor β_{T}(λ|IS)_{c}, apparent reflectance factor R*(λ|IS), or a coefficient of absorption K_{c}(λ), scattering S_{c}(λ) and fluorescence F_{c}(λ), or quantum efficiency Q, radiance transfer factor β(Ξ, λ) or extinction ε. The differential of the optical property is:

$$\frac{\partial {P}_{c} ( λ )}{\partial {( [ {D}_{total} ] )}_{f}} = {P}_{1} ( λ ) \frac{q}{{( 1 + {q [ {D}_{total} ]}_{f} )}^{2}} + {P}_{2} ( λ ) \frac{p}{{( 1 + {p [ {D}_{super} ]}_{f} )}^{2}} \frac{\partial [ {D}_{super} ]}{\partial {( [ {D}_{total} ] )}_{f}} \qquad ( 39 )$$

The differential of the optical property, which may or may not include fluorescence measured spectrophotometrically, can be expressed in a more general form as follows:

$$\frac{\partial P ( λ )}{\partial c} = {g}_{1} ( λ ) {f}_{1} ( c ) + {g}_{2} ( λ ) {f}_{2} ( c ) \qquad ( 40 )$$

where g₁(λ) describes for example the mono layer effect of colorant addition and g₂(λ) the super layer effect of colorant addition on the optical property, i.e. selected spectral function such as β(Ξ, λ) the functions of known concentration. Terms f₁(c) and f₂(c) are the functions of concentrations of in the case mono-layer and super layer on dye-on-adsorbent. The g₁(λ) and g₂(λ) are predetermined by measurements or a simulation. In paper coloring process, dye-on-adsorbent is equal to dye-on-fiber, more exactly dye-on-dry-solids. The concentration on dye-on-fiber can usually assumed to be the same as the concentration in the dye-bath in stock coloring of paper.

When fluorescence is present and it is measured in means of radiance transfer factors, the differential of the optical property can be expressed in a more general form as:

$$\frac{\partial P ( ζ , λ )}{\partial c} = {g}_{1} ( ζ , λ ) {f}_{1} ( c ) + {g}_{2} ( ζ , λ ) {f}_{2} ( c ) \qquad ( 41 )$$

where g₁(Ξ, λ) and g₂(Ξ, λ) are predetermined by measurements or a simulation and g₁(Ξ, λ) describes for example the mono layer effect of colorant addition and g₂(Ξ, λ) the super layer effect of colorant addition on the optical property, i.e selected spectral function such as β(Ξ, λ), β_{T}(λ|IS) or R*(λ|IS) the functions of known concentration. Correspondingly, f₁(c) and f₂(c) are functions of concentration in the case of mono layer and super layer on dye-on-adsorbent.

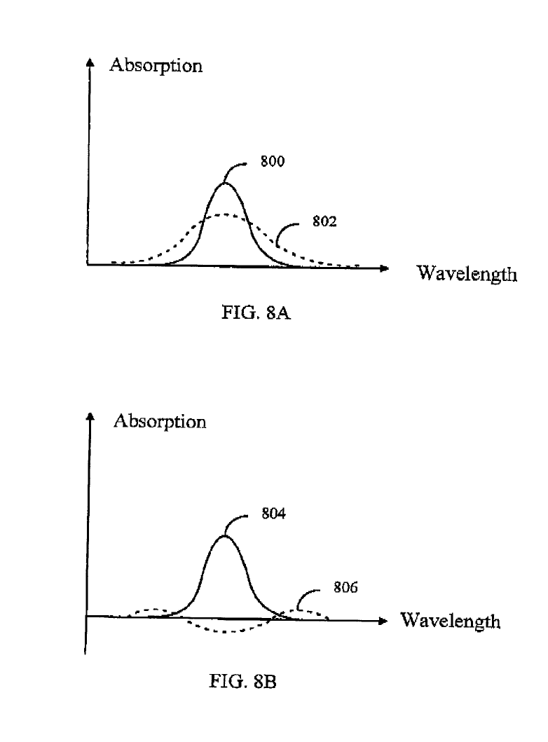

FIG. 8A shows the broadening effect. Curve 800 presents a change in absorption at a very low concentration

$$\frac{\partial P}{\partial c} {\vert}_{c \approx 0}$$

and curve 802 presents the change in absorption at a high concentration

$$\frac{\partial P}{\partial c} {\vert}_{c = large}$$

when the concentration changes by the same amount in both cases. FIG. 8B shows how the broadening affect can be taken into account. The reference behavior of another optical property is known from the measurements or simulation and it is represented by curve 804, which corresponds to a function g₁(Ξ, λ) or g₁(λ). The broadening effect is taken into account in curve 806 that corresponds to a function g₂(Ξ, λ) or g₂(λ). The combination of curves 804 and 806 form broadened curve 802.

The method utilizing the change in absorption caused by non-fluorescent colorant and particularly FBAs in their absorption band, and scattering information of undyed or possibly even dyed objects to be measured (for example sheets), is useful for modeling FBAs either using traditional color control technology based an spectrophotometric on-line measurements with off-line FBA modeling by dual monochromator or next generation color control based on only dual monochromatic color measurements.

An important aspect in the described coloring model is to determine the radiance transfer factor β(Ξ, λ) which allows the emission caused by the fluorescence and, thereby, the effect of the fluorescence on the color of the object to colored to be controlled, as well as to control the absorption and the emission process. On the basis of the coloring model, the differentials of the color space variables or the reflectance can be determined with respect to each colorant cⱼ. Colorimetric color matching is typically performed by minimizing the tristimulus errors and when tristimulus values are used according to the coloring model, the differentials

$$\frac{\partial X}{\partial c j} , \frac{\partial Y}{\partial c j} and \frac{\partial Z}{\partial c j}$$

of the color space variables X, Y and Z with respect to each colorant cⱼ can be expressed as

$$[ \begin{matrix}\frac{\partial X}{\partial {c }_{j}} \\ \frac{\partial Y}{\partial {c}_{j}} \\ \frac{\partial Z}{\partial {c }_{j}}\end{matrix} ] = {\sum }_{λ = 380}^{780} \{ S ( λ ) [ \begin{matrix}\overline{x} ( λ ) \\ \overline{y} ( λ ) \\ \overline{z} ( λ )\end{matrix} ] [ \frac{\partial {β}_{T} ( λ \vert I S )}{\partial c j} ] \} \qquad ( 42 )$$

Although the solution is here shown in an X, Y, Z color coordinate system, a similar solution can be shown in other color coordinate systems. The radiance transfer factor β(Ξ, λ) or luminescence radiance transfer factor β_{L}(Ξ, λ) based on the coloring model having thus been generated, the coloring model can be used to minimize, or eliminate, color difference between the substrate to be colored and the desired color. Also the coloring model for spectral property of the substrate, such as R*(λ|IS), T*(λ|IS) or β(Ξ, λ) R(λ), containing at least two terms comprising a product of a spectral function and a function of concentration, and where not all spectral functions of all terms are identical can be used to minimize, or eliminate, color difference between the substrate to be colored and the desired color.

From the described coloring model as given in formulas (10) and (11) the total radiance transfer factor β_{T}(λ|IS) calculated based on formula (43). The total radiance transfer factor β_{T}(λ|IS) can be expressed as:

$$βγ ( λ \vert I S ) = ( 1 + \frac{K ( λ )}{S ( λ )} - \frac{N ( λ )}{S ( λ )} ) + \frac{{\sum }_{{ζ}_{n}}^{ζ < λ} \frac{{K}_{F} ( ζ ) Q ( ζ , λ )}{2 ( N ( ζ ) + N ( λ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} ) S ( ζ ) δ ζ}{S ( λ ) δ λ} , \qquad ( 43 )$$

where the term

$$( 1 + \frac{K ( λ )}{S ( λ )} - \frac{N ( λ )}{S ( λ )} )$$

corresponds to the reflectance factor R(λ), N(x)=\sqrt{K(x)²+2K(x)S(x)} where x is either the variable Ξ or λ and δλ and δΞ mean instrumental wavelengths of intervals of the measuring instrument. From the described coloring model as given in formulas (40) and (41), where the effect of at least one fluorescent ingredient on an optical spectral property, such as apparent reflectance factor or apparent transmittance factor or total radiance factor, of the substrate can be used directly to minimize the color error for at least one specified condition of illumination.

We shall now examine in more detail how the color difference and the colorant are determined by applying the solution of the invention to prior art known per se. From the point of view of the invention, it is not essential how the difference in color is measured or how the amount of the colorant to be added is calculated on the basis of the measured difference in color or the desired change in color. An essential aspect is that the amount colorant to be added is determined using the above coloring models which describes the effect of said at least one fluorescent ingredient on the radiance transfer factor or apparent reflectance factor. In case of non-fluorescent colorant the above coloring model describes the reflectance or transmittance factor.

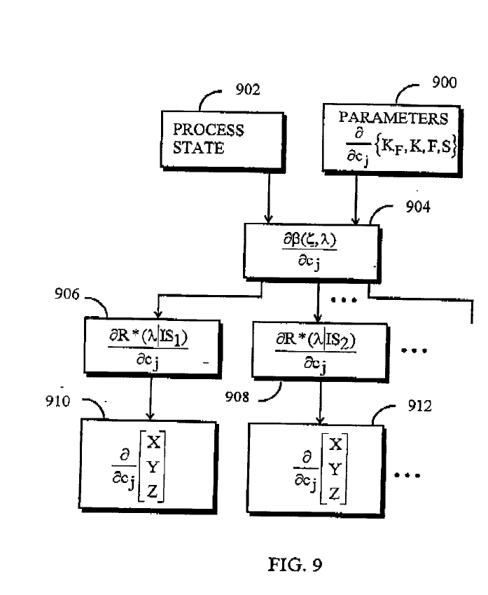

The function of color control is to minimize specified color errors by governing the available colorants' dosage. The color control is based on a coloring model that will now be examined with reference to FIG. 9. In block 900 of the disclosed solution, it is important to know parameters, i.e. the ratio ∂K/∂cⱼ of the absorption coefficient differential to the amount of the fluorescent ingredient to be added; the ratio ∂s/∂cⱼ of the scattering coefficient differential to the amount of the fluorescent ingredient to be added; and the ratio ∂F/∂cⱼ of the fluorescence coefficient differential to the amount of the fluorescent ingredient to be added, and to measure the state of the process, as shown in block 902. Because there are a plurality of total radiance transfer factors β_{T}(λ|IS) that correspond to the same perceived color, in block 904 the described coloring model produces the ratio ∂β(Ξ, λ)/∂cⱼ of the change in an optimized radiance transfer factor β to the amount of the fluorescent ingredient on the basis of the process state measurement data and parameters that may be dependent or independent on the process state. Thereafter, color control proceeds in a prior art manner known per se. Total radiance transfer factor ∂β_{T}(λ/|IS)/∂cⱼ with respect to the amount of the fluorescent ingredient can be determined at different conditions of illumination ISₗ in blocks 906-908. This allows the substrate to be colored to be provided with a desired illuminator metamerism where spectral radiances of samples match under one illuminator ISₖ, but not under another ISₘ. The blocks 906-908 determine the total transfer factor ∂β_{T}(λ|IS)/∂cⱼ especially in the presented solution containing a fluorescent extension for Kubelka-Munk theory. The block 904 can form instead of the radiance transfer factor ∂β(Ξ, λ)/∂cⱼ an apparent reflectance R*(λ|IS) or a true reflectance R(λ). In cases of true reflectance, the results enter directly from the block 904 to blocks 910-912. With the metamerism, the substrate to be colored can also be colored such that the spectral radiances of the substrate to be colored remain the same, irrespective of changes in the source of illumination. Similarly, it is possible to formulate the change in color ∂|X, Y, Z|/∂cⱼ in the observer's color space with respect to the amount of the fluorescent ingredient in blocks 910-912. The described coloring model primarily comprises blocks 900, 904, 906 908. The coloring model can also include blocks 910-912. When using the Langmuir isotherm the block 900 has the parameters determined in formulas (40) and (41).

The adding Δcⱼ of each fluorescent colorant thus causes a change in the radiance transfer factor β(Ξ, λ) or in the luminescence radiance transfer factor β_{L}(Ξ, λ), and correspondingly to formula (43) in total radiance factor under specified illumination. These changes cause a change ΔX, ΔY and ΔZ in each co-ordinate axis of the color space. For example, in connection with the fine control of a color shade, the solution of the invention can be disclosed in the following simple form

$$Δ X = {\sum }_{j = 1}^{N} ( \frac{\partial X}{\partial {c}_{j}} ) Δ {c}_{j} , \\ Δ Y = {\sum }_{j = 1}^{N} ( \frac{\partial Y}{\partial {c}_{j}} ) Δ {c}_{j} and \\ Δ Z = {\sum }_{j = 1}^{N} ( \frac{\partial Z}{\partial {c}_{j}} ) Δ {c}_{j} . \qquad ( 44 )$$

The disclosed solution also allows for major color changes, because data about the coloring processes carried out are stored into the coloring model. The coloring model can thus be used for determining the amounts Δc₁, Δc₂, . . . Δc_{N} of the colorants to be added, when the desired change in color Δx, ΔY and ΔZ is known.

With the coloring model, it is possible to influence the design and selection of the coloring process; the coloring model can be used prior to the coloring for selecting the colorants that are needed and how existing colorants are used. It can also be used for determining at which point of the process each colorant is to be added, because not all colorants may be added at the same time. Further, the coloring model allows the amount of colorants and colorant dosages to be minimized, which reduces costs. The coloring model also makes it possible to influence the operation of the coloring process, and to identify the relations of the process; thereby the coloring process can be carried out taking into account also the effect of other substances than those used in the actual coloring on the color to be produced.

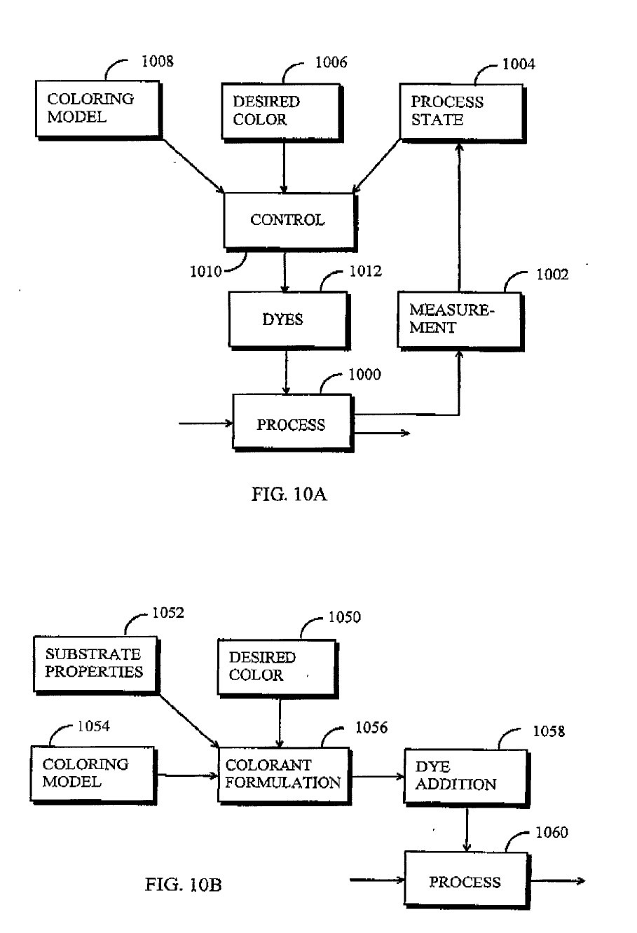

FIG. 10A illustrates a feedback arrangement for color measurement. Process 1000 is measured with at least one measuring head 1002 in which measurement signal processing can be carried out as well. The measuring head 1002 is used for measuring the transmittance or reflectance factor, radiance transfer factor β(Ξ, λ) or apparent reflectance factor R*(λ|IS) of the substrate to be colored. The process state measurement signal is transferred to a process state determining block 1004 where at least the process effective absorption coefficient K_{F}, absorption coefficient K, scattering coefficient S and fluorescence coefficient F are determined. Instead of the fluorescence, coefficient F quantum efficiency coefficient Q can be determined. Other factors having an effect on the coloring can also be measured from the process. Any other colorant or the substrate to cause absorption band competition or dynamic or static reduction of fluorescent emission can be identified and taken into account in the coloring process. In addition, for example substances other than actual colorants added to the process and having an effect on the radiance transfer factor change when the fluorescent ingredient is added can be taken into account. The measurements are used for generating the optical property like the radiance transfer factor β(Ξ, λ) or the luminescence radiance transfer factor β_{L}(Ξ, λ) and its differential ∂β(Ξ, λ)/∂cⱼ, which in turn allow the color of the object in the process to be determined in the desired color space (in an X, Y, Z or L*, a*, b* co-ordinate system, for example) in block 1004. In block 1006 is determined a color target of the object to be measured and processed, The color target is determined for example with reference to a desired color space and desired conditions of viewing. The conditions of viewing are influenced by the illuminator and the angle of viewing. Block 1008 comprises the coloring model of the invention, the coloring model comprising the differentials ∂K/∂cⱼ, ∂S/∂cⱼ and ∂F/∂cⱼ. Control block 1010 that represents means for controlling aims at minimizing, or eliminating, color difference between the color target and the substrate to be colored by using the signals coming from the blocks 1004-1008. The different variables of the color space can be differently weighted in control block 1010. For example, if the color of the substrate to be colored is determined as X₁, Y₁, Z₁ in the tristimulus color space, the weighted color obtained is w₁·X₁, w₂·Y₁, w₃·Z₁, where w₁, w₂ and w₃ represent the weighting coefficients (reference being made to blocks 910-912 in FIG. 9). The color target can be similarly weighted. It is also possible to weight apparent reflectance factors R*(λ|IS) of different conditions of illumination (reference being made to blocks 906-908 in FIG. 9). In the described solution, apparent reflectance factor R*(λ|IS₁) can be weighted in a desired manner, for example: w₁·R*(λ|IS₁), w₂·R*(λ|IS₂), . . . , wp·R*(λ|IS_{N}) where w₁, . . . , w_{P} are weighting coefficients, some of which may also receive the value zero. Instead of reflectance coefficients R*(λ|IS₁) . . . R*(λ|IS_{N}) total radiance factors β_{T}(λ|IS₁) . . . β_{T}(λ|IS_{N}) can be used. Weighting has an effect on the calculation of the color difference, for example, and, compared with a non-weighted situation, it causes a change in the color substance dosage. Control block 1010 generates a control signal to coloring block 1012 that represents means for adding at least one ingredient in the coloring process. The coloring block 1012 thus uses the control signal to regulate the dosage of the colorants to the object of measurement in such a way that the object to be measured receives a color that is as close as possible to the color target.

FIG. 10B shows a block diagram of color control for a batch and a feedforward process in which the color target of the substrate to be colored is determined in block 1050. The properties of the substrate to be colored are measured in block 1052 prior to the coloring. In the measurement, a sample is taken from the batch, the properties of the sample being then measured, and the measurements are assumed to apply to the whole batch. In addition, a coloring model 1054 to be used, ie the present coloring model, is determined. On the basis of signals coming from blocks 1050, 1052 and 1054, the colorants needed in the coloring and their amounts are determined in block 1056. The control signal transmitted from block 1056 controls the colorants to be added to the coloring process 1060 and their amount in block 1058 such that the color of the object to be measured is as close as possible to the one desired. In a feedforward process the properties of the substrate to be colored change constantly, therefore the substrate to be colored is measured prior to the coloring, the ingredients to be used in the coloring being dosed on the basis of the measurement separately for each substrate to be colored.

Although the invention is described above with reference to an example shown in the attached drawings, it is apparent that the invention is not restricted to it, but can vary in many ways within the inventive idea disclosed in the attached claims.

What is claimed is:

1. A method for controlling a coloring process, the method comprising
adding at least one fluorescent ingredient in the coloring process;
determining the addition amount of said at least one fluorescent ingredient by using a model which describes the effect of at least said at least one fluorescent ingredient on a radiance transfer factor for a substrate to be colored.

2. A method for controlling a coloring process, the method comprising
adding at least one soluble ingredient into a coloring solution;
exposing a solid substrate to said coloring solution, and thereafter separating said solid substrate from said solution:
determining the addition amount of said at least one soluble ingredient to impart a desired color to the substrate by using a model which describes in combination:
the adsorption or deposition or absorption of said at least one dissolved soluble ingredient onto the surface or into the material of said solid substrate in terms of a concentration of said soluble ingredient in the coloring process, and
the effect of adsorbed or deposited or absorbed said at least one soluble ingredient on an optical spectral property of said said substrate,
wherein said model contains at least two terms for the at least one soluble ingredient, the terms being added or subtracted, and each of said at least two terms comprising a product of a spectral function and a function of concentration, and not all spectral functions of all terms are identical, the model generally taking the form
$$\frac{\partial p ( λ )}{\partial c} = {g}_{1} ( λ ) {f}_{1} ( c ) + {g}_{2} ( λ ) {f}_{2} ( c )$$
where p(λ) is the spectral property of the substrate, g₁(λ) and g₂(λ) are known spectral functions which are not identical, and f₁(c) and f₂(c) are known functions of concentration.

3. A method for controlling a coloring process, the method comprising
adding at least one fluorescent ingredient in the coloring process;
determining the addition amount of said at least one fluorescent ingredient to impart a desired color to the substrate by using a model which describes the effect of at least said at least one fluorescent ingredient on a radiance transfer factor for a substrate to be colored;
said model contains at least one term for the at least one fluorescent ingredient, the term comprising a product of a spectral transfer function and a function of concentration, the model generally taking the form
$$\frac{\partial p ( ζ , λ )}{\partial c} = g ( ζ , λ ) f ( c )$$
where p(Ξ, λ) is the radiance transfer factor of the substrate, g(Ξ, λ) is a known spectral transfer function, and f(c) is a known function of concentration.

4. A method as claimed in claim 3, wherein the concentration value used in the function of concentration is either (i) the concentration of the fluorescent ingredient in the process, or (ii) the concentration of the fluorescent ingredient in said solid substrate.

5. A method for controlling a coloring process, the method comprising
adding at least one fluorescent ingredient in the coloring process;
determining the addition amount of said at least one fluorescent; ingredient to impart a desired color to the substrate by using a model which describes the effect of at least said at least one fluorescent ingredient on a radiance transfer factor for a substrate to be colored;
said model contains at least two terms for the at least one fluorescent ingredient, each term comprising a product of a spectral transfer function and a function of concentration, one spectral transfer function differs from at least one other spectral transfer function, the model generally taking the form
$$\frac{\partial p ( ζ , λ )}{\partial c} = {g}_{1} ( ζ , λ ) {f}_{1} ( c ) + {g}_{2} ( ζ , λ ) {f}_{2} ( c )$$
where p(Ξ, λ) is the radiance transfer factor of the substrate, g₁(Ξ, λ) and g₂(Ξ, λ) are known spectral transfer functions which are not identical, and f₁(c) and f₂(c) are known functions of concentration.

6. A method as claimed in claim 5, wherein the concentration value used in at least one of the two functions of concentration is either the concentration of the fluorescent ingredient in the process, or the concentration of the fluorescent ingredient in said solid substrate.

7. A method for controlling a coloring process, the method comprising
adding at least one fluorescent ingredient in the coloring process;
determining the addition amount of said at least one fluorescent ingredient to impart a desired color to the substrate by using a model which describes the effect of at least said at least one fluorescent ingredient on a radiance transfer factor for a substrate to be colored;
the radiance transfer factor being determined from:
the optical absorption coefficient and the optical scattering coefficient for at least two wavelengths in the fluorescent excitation band,
the optical absorption coefficient and the optical scattering coefficient for at least two wavelengths in the fluorescent emission band, and the quantum efficiency of the fluorescence from said at least two excitation wavelengths to said at least two emission wavelength, and wherein said optical absorption coefficients and said optical scattering coefficients are determined at each wavelength using at least one known function of concentration.

8. A method as claimed in claim 1, wherein the radiance transfer factor is a luminescence radiance transfer factor.

9. A method as claimed in claim 8, wherein the luminescence radiance transfer factor β_{L}(Ξ, λ) is expressed as:
$${β}_{L} ( ζ , λ ) = \frac{{K}_{F} ( ζ ) Q ( ζ , λ )}{2 ( N ( λ ) + N ( ζ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} )$$
where N(x)=\sqrt{K(x)²+2K(x)S(x)}, K_{F}(Ξ) is the effective absorption coefficient calculated as K_{F}(Ξ)=K_{c}(Ξ)−Kₛ(Ξ), K_{c}(Ξ) is absorption coefficient for a colored substrate and Kₛ(Ξ) is absorption coefficient for a base substrate, x can be replaced by variable Ξ or λ, the variable Ξ represents the wavelength of the exciting radiance and λ the emitting wavelength, K(λ) and K(Ξ) are absorption coefficients, S(λ) and S(Ξ) are scattering coefficients and Q(Ξ, λ) is a quantum efficiency coefficient.

10. A method as claimed in claim 8, wherein the luminescence radiance transfer factor β_{L}(Ξ, λ) is expressed as:
$${β}_{L} ( ζ , λ ) = \frac{F ( ζ , λ )}{2 ( N ( λ ) + N ( ζ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} )$$
where F(Ξ, λ) is a term describing the fluorescence, N(x)=\sqrt{K(x)²+2K(x)S(x)}, K_{F}(Ξ) is the effective absorption coefficient calculated as K_{F}(Ξ)=K_{c}(Ξ)−Kₛ(Ξ), K_{c}(Ξ) is absorption coefficient for a colored substrate and Kₛ(Ξ) is absorption coefficient for a base substrate, and where x can be replaced by variable Ξ or λ, and the variable Ξ represents the wavelength of the exciting radiance and λ the emitting wavelength, K(λ) and K(Ξ) are absorption coefficients, S(λ) and S(Ξ) are scattering coefficients and Q(Ξ, λ) is a quantum efficiency coefficient.

11. A method as claimed in claim 1, wherein the radiance transfer factor is either a radiance transfer factor for remitted radiance, or a radiance transfer factor for transmitted radiance.

12. A method as claimed in claim 1, wherein the effect of the at least one fluorescent ingredient on the total radiance factor of the substrate is determined for at least one specified condition of illumination.

13. A method as claimed in claim 12, wherein the total radiance factor is either the apparent reflectance, or the apparent transmittance.

14. A method as claimed in claim 1, wherein the coloring process is a continuous process.

15. A method as claimed in claim 1, wherein the coloring process is a batch process.

16. A method according to claim 1, wherein the color of the substrate to be colored is determined prior to the coloring and the color of a substrate is controlled by determining the amount of the ingredient to be added on the basis of the determined color and the coloring model.

17. A method according to claim 1, wherein the coloring process is a batch process, a sample being taken from a batch and the color of the sample is measured to determine the color of the entire batch for controlling the coloring of the substrate to be colored in the batch.

18. A method according to claim 1, wherein the coloring process is a feedforward coloring process, the color being measured prior to the coloring of each substrate to be colored and the color of a substrate is controlled by determining the amount of the ingredient to be added on the basis of the measured color and the coloring model.

19. A method according to claim 1, wherein a measured color is compared with a color target to determine the difference in color, the color of a substrate is controlled by determining the amount of the fluorescent ingredient to be added using the color difference and the coloring model.

20. A method according to claim 1, wherein the coloring process is a feedback coloring process where the color of the substrate to be colored is measured after the color has been added, and the color of a substrate is controlled by determining the amount of the fluorescent ingredient to be added to correct the difference in color observed on the basis of a comparison.

21. A method according to claim 1, wherein color targets with respect to at least two illumination conditions are given and at least one fluorescent ingredient is added such that in each illumination condition the color targets are achieved in the substrate to be colored.

22. A method according to claim 1, wherein during the coloring process ingredients that form a fluorescence cascade are added into the substrate to be colored.

23. A method according to claim 1, wherein the color of the substrate to be colored is compared with the color target using at least one of the following:
a total radiance factor for a specified condition of illumination,
a desired color space for a specified condition of illumination,
the absorption coefficient K_{F} for excitation of fluorescence, the absorption coefficient K, the scattering coefficient S, and the quantum efficiency Q included in the coloring model,
a radiance transfer factor β(Ξ, λ); and
the color of a substrate is controlled by determining the amount of said at least one ingredient to be added by using the result of the comparison and the coloring model.

24. A method as claimed in claim 2, wherein the concentration value used in at least one of the at least two functions of concentration is one of the following;
the concentration of the dissolved soluble ingredient in the coloring solution,
the surface concentration of the soluble ingredient adsorbed or deposited onto the surface of the solid substrate,
the surface concentration of the soluble ingredient adsorbed or deposited as a monolayer onto the surface of the solid substrate,
the surface concentration of the soluble ingredient adsorbed or deposited as a superlayer above a monolayer on the surface of the solid substrate,
the concentration of the soluble ingredient absorbed into the material of the solid substrate.

25. A method as claimed in claim 2, wherein at least one of said at least one soluble ingredient is a fluorescent ingredient.

26. A method as claimed in claim 2, in wherein the method for separating the solid material from the coloring solution forms a sheet of the separated solid material.

27. A method as claimed in claim 2, wherein the optical spectral property is one of the following:
the true reflectance of the substrate,
the apparent reflectance of the substrate for a specified condition of illumination,
the true transmittance of the substrate
the apparent transmittance of the substrate for a specified condition of illumination,
the optical absorption coefficient of the substrate,
the optical scattering coefficient of the substrate,
the fluorescent emission of the substrate for a specified condition of illumination.

28. A method as claimed in claim 2, wherein the coloring process is a continuous process.

29. A method as claimed in claim 2, wherein the coloring process is a batch process.

30. A method according to claim 2, wherein the color of the substrate to be colored is determined prior to the coloring and the color of a substrate is controlled by determining the amount of the ingredient to be added on the basis of the determined color and the coloring model.

31. A method according to claim 2, wherein the coloring process is a batch process, a sample being taken from a batch and the color of the sample is measured to determine the color of the entire batch for controlling the coloring of the substrate to be colored in the batch.

32. A method according to claim 2, wherein the coloring process is a feedforward coloring process, the color being measured prior to the coloring of each substrate to be colored and the color of a substrate is controlled by determining the amount of the ingredient to be added on the basis of the measured color and the coloring model.

33. A method according to claim 2, wherein a measured color is compared with a color target to determine the difference in color, the color of a substrate is controlled by determining the amount of the fluorescent ingredient to be added using the color difference and the coloring model.

34. A method according to claim 2, wherein the coloring process is a feedback coloring process where the color of the substrate to be colored is measured after the color has been added, and the color of a substrate is controlled by determining the amount of the fluorescent ingredient to be added to correct the difference In color observed on the basis of a comparison.

35. A method according to claim 2, wherein color targets with respect to at least two illumination conditions are given and at least one fluorescent ingredient is added such that in each illumination condition the color targets are achieved in the substrate to be colored.

36. A method according to claim 2, wherein during the coloring process ingredients that form a fluorescence cascade are added into the substrate to be colored.

37. A method according to claim 2, wherein the color of the substrate to be colored is compared with the color target using at least one of the followings:
a total radiance factor for a specified condition of illumination,
a desired color space for a specified condition of illumination; and
the color of a substrate is controlled by determining the amount of said at least one ingredient to be added by using the result of the comparison and the coloring model.

38. A coloring apparatus which is arranged to
add at least one fluorescent ingredient in the coloring process;
determine the amount of said at least one fluorescent ingredient by using a model which describes the effect of said at least one fluorescent ingredient on the radiance transfer factor for the substrate to be colored.

39. A coloring apparatus which is arranged to
add at least one soluble ingredient into a coloring solution;
expose a solid substrate to said coloring process, and thereafter separating said solid substrate from said solution;
determine the addition amount of said at least one soluble ingredient to impart a desired color to the substrate by using a model which describes in combination:
the adsorption or deposition or absorption of said at least one dissolved soluble ingredient onto the surface or into the material of said solid substrate in terms of a concentration of said soluble ingredient in the coloring process, and the effect of adsorbed or deposited or absorbed said at least one soluble ingredient on an optical spectral property of said solid substrate,
wherein said model contains at least two terms for the at least one soluble ingredient, the terms being added or subtracted, and each of said at least two terms comprising a product of a spectral function and a function of concentration, and not all spectral functions of all terms are identical, the model generally taking the form
$$\frac{\partial p ( λ )}{\partial c} = {g}_{1} ( λ ) {f}_{1} ( c ) + {g}_{2} ( λ ) {f}_{2} ( c )$$
where p(λ) is the spectral property of the substrate, g₁(λ) and g₂(λ) are known spectral functions which are not identical, and f₁(c) and f₂(c) are known functions of concentration.

40. A coloring apparatus which is arranged to
add at least one fluorescent ingredient in the coloring process;
determine the addition amount of said at least one fluorescent ingredient to impart a desired color to the substrate by using a model which describes the effect of at least said at least one fluorescent ingredient on a radiance transfer factor for a substrate to be colored;
said model contains at least one term for the at least one fluorescent ingredient, the term comprising a product of a spectral transfer function and a function of concentration, the model generally taking the form
$$\frac{\partial p ( ζ , λ )}{\partial c} = g ( ζ , λ ) f ( c )$$
where p(Ξ, λ) is the radiance transfer factor of the substrate, g(Ξ, λ) is a known spectral transfer function, and f(c) is a known function of concentration.

41. A coloring apparatus according to claim 40, wherein the concentration value used in the function of concentration is either the concentration of the fluorescent ingredient in the process, or the concentration of the fluorescent ingredient in said solid substrate.

42. A coloring apparatus which is arranged to
add at least one fluorescent ingredient in the coloring process;
determine the addition amount of said at least one fluorescent; ingredient to impart a desired color to the substrate by using a model which describes the effect of at least said at least one fluorescent ingredient on a radiance transfer factor for a substrate to be colored;
said model contains at least two terms for the at least one fluorescent ingredient each term comprising a product of a spectral transfer function and a function of concentration, one spectral transfer function differs from at least one other spectral transfer function, the model generally taking the form
$$\frac{\partial p ( ζ , λ )}{\partial c} = {g}_{1} ( ζ , λ ) {f}_{1} ( c ) + {g}_{2} ( ζ , λ ) {f}_{2} ( c )$$
where p(Ξ, λ) is the radiance transfer factor of the substrate, g₁(Ξ, λ) and g₂(Ξ, λ) are known spectral transfer functions which are not identical, and f₁(c) and f₂(c) are known functions of concentration.

43. A coloring apparatus according to claim 42, wherein the concentration value used In at least one of the two functions of concentration is either (i) the concentration of the fluorescent ingredient in the process or (ii) the concentration of the fluorescent ingredient in said solid substrate.

44. A coloring apparatus which is arranged to
add at least one fluorescent ingredient in the coloring process;
determine the addition amount of said at least one fluorescent ingredient to impart a desired color to the substrate by using a model which describes the effect of at least said at least one fluorescent ingredient on a radiance transfer factor for a substrate to be colored;
the radiance transfer factor being determined from:
the optical absorption coefficient and the optical scattering coefficient for at least two wavelengths in the fluorescent excitation band,
the optical absorption coefficient and the optical scattering coefficient for at least two wavelengths in the fluorescent emission band, and the quantum efficiency of the fluorescence from said at least two excitation wavelengths to said at least two emission wavelength, and wherein said optical absorption coefficients and said optical scattering coefficients are determined at each wavelength using at least one known function of concentration.

45. A coloring apparatus according to claim 35, wherein the radiance transfer factor is a luminescence radiance transfer factor.

46. A coloring apparatus according to claim 45, wherein the luminescence radiance transfer factor β_{L}(Ξ, λ) is expressed as:
$${β}_{L} ( ζ , λ ) = \frac{{K}_{F} ( ζ ) Q ( ζ , λ )}{2 ( N ( λ ) + N ( ζ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} )$$
where N(x)=\sqrt{K(x)²+2K(x)S(x)}, K_{F}(Ξ) is the effective absorption coefficient calculated as K_{F}(Ξ)=K_{c}(Ξ)−Kₛ(Ξ), K_{c}(Ξ) is absorption coefficient for a colored substrate and Kₛ(Ξ) is absorption coefficient for a base substrate, x can be replaced by variable Ξ or λ, the variable Ξ represents the wavelength of the exciting radiance and λ the emitting wavelength, K(λ) and K(Ξ) are absorption coefficients, S(λ) and S(Ξ) are scattering coefficients and Q(Ξ, λ) is a quantum efficiency coefficient.

47. A coloring apparatus according to claim 45, wherein the luminescence radiance transfer factor β_{L}(Ξ, λ) is expressed as:
$${β}_{L} ( ζ , λ ) = \frac{F ( ζ , λ )}{2 ( N ( λ ) + N ( ζ ) )} ( 2 + \frac{K ( ζ )}{S ( ζ )} - \frac{N ( ζ )}{S ( ζ )} ) ( 2 + \frac{K ( λ )}{S ( λ )} - \frac{N ( λ )}{S ( λ )} )$$
where F(Ξ, λ) is a term describing the fluorescence, N(x)=\sqrt{K(x)²+2K(x)S(x)}, K_{F}(Ξ) is the effective absorption coefficient calculated as K_{F}(Ξ)=K_{c}(Ξ)−Kₛ(Ξ), K_{c}(Ξ) is absorption coefficient for a colored substrate and Kₛ(Ξ) is absorption coefficient for a base substrate, and where x can be replaced by variable Ξ or λ, and the variable Ξ represents the wavelength of the exciting radiance and λ the emitting wavelength, K(λ) and K(Ξ) are absorption coefficients, S(λ) and S(Ξ) are scattering coefficients and Q(Ξ, λ) is a quantum efficiency coefficient.

48. A coloring apparatus according to claim 38, wherein the radiance transfer factor is either a radiance transfer factor for remitted radiance, or a radiance transfer factor for transmitted radiance.

49. A coloring apparatus according to claim 38, wherein the apparatus is arranged to determine the effect of the at least one fluorescent ingredient on the total radiance factor of the substrate for at least one specified condition of illumination.

50. A coloring apparatus according to claim 49, wherein the total radiance factor is either the apparent reflectance, or the apparent transmittance.

51. A coloring apparatus according to claim 38, wherein the coloring process is a continuous process.

52. A coloring apparatus according to claim 38, wherein the coloring process is a batch process.

53. A coloring apparatus according to claim 38, wherein the color of the substrate to be colored is determined prior to the coloring and the apparatus is arranged to control the color of a substrate by determining the amount of the ingredient to be added on the basis of the determined color and the coloring model.

54. A coloring apparatus according to claim 38, wherein the coloring process is a batch process, a sample being taken from a batch and the apparatus is arranged to measure the color of the sample to determine the color of the entire batch for controlling the coloring of the substrate to be colored in the batch.

55. A coloring apparatus according to claim 38, wherein the coloring process is a feedforward coloring process, the color being measured prior to the coloring of each substrate to be colored and the apparatus is arranged to control the color of a substrate by determining the amount of the ingredient to be added on the basis of the measured color and the coloring model.

56. A coloring apparatus according to claim 38, wherein the apparatus is arranged to compare a measured color kith a color target to determine the difference in color, and the apparatus is arranged to control the color of a substrate by determining the amount of the fluorescent ingredient to be added using the color difference and the coloring model.

57. A coloring apparatus according to claim 38, wherein the coloring process is a feedback coloring process where the color of the substrate to be colored is measured after the color has been added, and the apparatus is arranged to control the color of a substrate by determining the amount of the fluorescent ingredient to be added to correct the difference in color observed on the basis of a comparison.

58. A coloring apparatus according to claim 38, wherein color targets with respect to at least two illumination conditions are given and the apparatus is arranged to add at least one fluorescent ingredient such that in each illumination condition the color targets are achieved in the substrate to be colored.

59. A coloring apparatus according to claim 38, wherein the apparatus is arranged to add during the coloring process ingredients that form a fluorescence cascade into the substrate to be colored.

60. A coloring apparatus according to claim 38, wherein the apparatus is arranged to compare the color of the substrate to be colored with a color target using at least one of the following:
a total radiance factor for a specified condition of illumination,
a desired color space for a specified condition of illumination,
the absorption coefficient K_{F} for excitation of fluorescence, the absorption coefficient K, the scattering coefficient S, and the quantum efficiency Q included in the coloring model,
a radiance transfer factor β(Ξ, λ); and
the apparatus is arranged to control be color of a substrate by determining the amount of said at least one ingredient to be added by using the result of the comparison and the coloring model.

61. A coloring apparatus according to claim 39, wherein the concentration value used in at least one of the at least two functions of concentration is one of the following:
the concentration of the dissolved soluble ingredient in the coloring solution,
the surface concentration of the soluble ingredient adsorbed or deposited onto the surface of the solid substrate,
the surface concentration of the soluble ingredient adsorbed or deposited as a monolayer onto the surface of the solid substrate,
the surface concentration of the soluble ingredient adsorbed or deposited as a superlayer above a monolayer on the surface of the solid substrate,
the concentration of the soluble ingredient absorbed into the material of the solid substrate.

62. A coloring apparatus according to claim 39, wherein at least one of said at least one soluble ingredient is a fluorescent ingredient.

63. A coloring apparatus according to claim 39, in wherein separation the solid material from the coloring solution forms a sheet of the separated solid material.

64. A coloring apparatus according to claim 39, wherein the optical spectral property is one of the following:
the true reflectance of the substrate,
the apparent reflectance of the substrate for a specified condition of illumination,
the true transmittance of the substrate
the apparent transmittance of the substrate for a specified condition of illumination,
the optical absorption coefficient of the substrate,
the optical scattering coefficient of the substrate,
the fluorescent emission of the substrate for a specified condition of illumination.

65. A coloring apparatus according to claim 39, wherein the coloring process is a continuous process.

66. A coloring apparatus according to claim 39, wherein the coloring process is a batch process.

67. A coloring apparatus according to claim 39, wherein the color of the substrate to be colored is determined prior to the coloring and the apparatus is arranged to control the color of a substrate by determining the amount of the ingredient to be added on the basis of the determined color and the coloring model.

68. A coloring apparatus according to claim 39, wherein the coloring process is a batch process, a sample being taken from a batch and the apparatus is arranged to measure the color of the sample to determine the color of the entire batch for controlling the coloring of the substrate to be colored in the batch.

69. A coloring apparatus according to claim 39, wherein the coloring process is a feedforward coloring process, the color being measured prior to the coloring of each substrate to be colored and the apparatus is arranged to control the color of a substrate by determining the amount of the ingredient to be added on the basis of the measured color and the coloring model.

70. A coloring apparatus according to claim 39, wherein the apparatus is arranged to compare a measured color with a color target to determine the difference in color, and the apparatus is arranged to control the color of a substrate by determining the amount of the fluorescent ingredient to be added using the color difference and the coloring model.

71. A coloring apparatus according to claim 39, wherein the coloring process is a feedback coloring process where the color of the substrate to be colored is measured after the color has been added, and the apparatus is arranged to control the color of a substrate by determining the amount of the fluorescent ingredient to be added to correct the difference in color observed on the basis of a comparison.

72. A coloring apparatus according to claim 39, wherein color targets with respect to at least two illumination conditions are given and the apparatus is arranged to add at least one fluorescent ingredient such that in each illumination condition the color targets are achieved in the substrate to be colored.

73. A coloring apparatus according to claim 39, wherein the apparatus is arranged to add during the coloring process ingredients that form a fluorescence cascade into the substrate to be colored.

74. A coloring apparats according to claim 39, wherein the apparatus is arranged to compare the color of the substrate to be colored with the color target using at least one of the following:
a total radiance factor for a specified condition of illumination,
a desired color space for a specified condition of illumination; and the apparatus Is arranged to control the color of a substrate by determining the amount of said at least one ingredient to be added by using the result of the comparison and the coloring model.
